(19) United States
(12) Patent Application Publication
(10) Pub. No.: US 2022/0323959 A1
(43) Pub. Date: Oct. 13, 2022

(54) CARTRIDGE AND PARTICLE SORTING APPARATUS

(71) Applicant: Allied Flow Inc., Nishinomiya-shi, Hyogo (JP)

(72) Inventor: Masahiko KANDA, Nishinomiya-shi, Hyogo (JP)

(73) Assignee: Allied Flow Inc., Nishinomiya-shi, Hyogo (JP)

(21) Appl. No.: 17/616,876

(22) PCT Filed: Feb. 26, 2020
(86) PCT No.: PCT/JP2020/007815

§ 371 Date: Dec. 6, 2021

(51) Int. Cl. B01L 3/00

(52) U.S. Cl. CPC B01L 3/502761; B01L 3/502715; B01L 3/502753; B01L 3/502784; B01L 2400/0605; B01L 2300/0681; B01L 2200/0631

(57) ABSTRACT

A cartridge includes: a first reservoir capable of accommodating a sample liquid; a sheath liquid conduit; a sterilization filter; a mixer; a nozzle; a droplet collection member; and a check valve. The sterilization filter is provided at the sheath liquid conduit. The check valve is connected to a waste-droplet collection member. A sample liquid flow path and a sheath liquid flow path are isolated from a surrounding environment around the cartridge and are maintained in a sterile state. The sample liquid flow path extends from the first reservoir to the droplet collection member. The sheath liquid flow path extends from the sterilization filter to the droplet collection member.

### TECHNICAL FIELD

The present disclosure relates to a cartridge and a particle sorting apparatus.

### BACKGROUND ART

Due to progress in biotechnology, in various fields including medical science and biology, a demand has been increased for an apparatus that performs a process such as sorting or analysis on a multiplicity of cell particles, which are exemplary biological particles. As an example of such an apparatus, WO 2010/095391 (PTL 1) discloses a particle sorting apparatus.

### CITATION LIST

### Patent Literature

PTL 1: WO 2010/095391

### SUMMARY OF INVENTION

### Technical Problem

It is an object of a first aspect of the present disclosure to provide a cartridge by which particles can be sterilely sorted without carryover of a sample liquid and by which risk of biohazard to a user can be reduced. It is an object of a second aspect of the present disclosure to provide a particle sorting apparatus by which particles can be sorted without carryover of a sample liquid, by which risk of biohazard to a user can be reduced, and by which alignment can be readily made between a cartridge and an optical system while maintaining a sample liquid flow path in a sterile state.

### Solution to Problem

A cartridge of the present disclosure includes a first reservoir, a sheath liquid conduit, a first sterilization filter, a mixer, a nozzle, a droplet collection member, and a check valve. The first reservoir is capable of accommodating a sample liquid including particles. The first sterilization filter is provided at the sheath liquid conduit. The mixer is connected to the first reservoir and the sheath liquid conduit. The nozzle communicates with an inner cavity of the mixer. The droplet collection member is capable of collecting droplets released from the nozzle. The droplet collection member includes a waste-droplet collection member and a deflected-droplet collection member. The check valve is connected to the waste-droplet collection member. A sample liquid flow path and a sheath liquid flow path are isolated from a surrounding environment around the cartridge and are maintained in a sterile state. The sample liquid flow path extends from the first reservoir to the droplet collection member. The sheath liquid flow path extends from the first sterilization filter to the droplet collection member.

A particle sorting apparatus according to a first aspect of the present disclosure includes: the cartridge of the present disclosure; and a body to which the cartridge is attachable. The body includes: an optical system; and a moving mechanism capable of moving one of the cartridge and the optical system with respect to the other of the cartridge and the optical system. The optical system includes: a light source capable of emitting excitation light toward a flow channel that communicates with the inner cavity of the mixer and the nozzle; and an optical detector capable of detecting fluorescence or scattered light emitted from each of the particles that flow in the flow channel and that are irradiated with the excitation light.

A particle sorting apparatus according to a second aspect of the present disclosure includes: the cartridge of the present disclosure; and a body to which the cartridge is attachable. The body includes: an optical system; and a moving mechanism capable of moving one of the cartridge and the optical system with respect to the other of the cartridge and the optical system. The optical system includes: a light source capable of emitting excitation light toward a jet flow sent out from the nozzle; and an optical detector capable of detecting fluorescence or scattered light emitted from each of the particles that are included in the jet flow and that are irradiated with the excitation light.

### Advantageous Effects of Invention

According to the cartridge of the present disclosure, particles can be sterilely sorted without carryover of a sample liquid, and risk of biohazard to a user can be reduced. According to the particle sorting apparatus of the first aspect of the present disclosure and the particle sorting apparatus of the second aspect of the present disclosure, particles can be sterilely sorted without carryover of a sample liquid, risk of biohazard to a user can be reduced, and alignment can be readily made between the cartridge and the optical system while maintaining the sample liquid flow path and the sheath liquid flow path in the sterile state.

### BRIEF DESCRIPTION OF DRAWINGS

FIG. 1 is a schematic diagram of a particle sorting apparatus according to a first embodiment.

FIG. 2 is a schematic diagram of the particle sorting apparatus according to the first embodiment.

FIG. 3 is a schematic partial enlarged view of a jet flow, a break-off point, and droplets.

FIG. 4 is a control block diagram of the particle sorting apparatus according to the first embodiment.

FIG. 5 is a schematic diagram showing a flowchart of a particle sorting method according to the first embodiment.

FIG. 6 is a diagram showing a timing chart in the particle sorting method according to the first embodiment.

FIG. 7 is a schematic partial diagram of a particle sorting apparatus according to a first modification of the first embodiment.

FIG. 8 is a schematic perspective view of a mixer and a flow channel portion of a particle sorting apparatus according to a second modification of the first embodiment.

FIG. 9 is a schematic diagram of a particle sorting apparatus according to a second embodiment.

FIG. 10 is a schematic diagram of the particle sorting apparatus according to the second embodiment.

FIG. 11 is a schematic partial enlarged cross sectional view of a droplet collection destination changeable member and a droplet collection member of a particle sorting apparatus according to a third embodiment along a cross sectional line XI-XI shown in FIGS. 13 and 14.

FIG. 12 is a schematic partial enlarged cross sectional view of the droplet collection destination changeable member and the droplet collection member of the particle sorting apparatus according to the third embodiment along a cross sectional line XII-XII shown in FIGS. 13 and 14.

FIG. 13 is a schematic partial enlarged cross sectional view of the droplet collection destination changeable member and the droplet collection member of the particle sorting apparatus according to the third embodiment along a cross sectional line XIII-XIII shown in FIGS. 11 and 12.

FIG. 14 is a schematic partial enlarged cross sectional view of the droplet collection destination changeable member and the droplet collection member of the particle sorting apparatus according to the third embodiment along a cross sectional line XIV-XIV shown in FIGS. 11 and 12.

FIG. 15 is a schematic partial enlarged view of a droplet collection destination changeable member and a droplet collection member of a particle sorting apparatus according to a fourth embodiment.

FIG. 16 is a schematic diagram of a particle sorting apparatus according to a fifth embodiment.

FIG. 17 is a schematic diagram of the particle sorting apparatus according to the fifth embodiment.

### DESCRIPTION OF EMBODIMENTS

Hereinafter, embodiments will be described. It should be noted that the same configurations are denoted by the same reference characters and will not be described repeatedly.

### First Embodiment

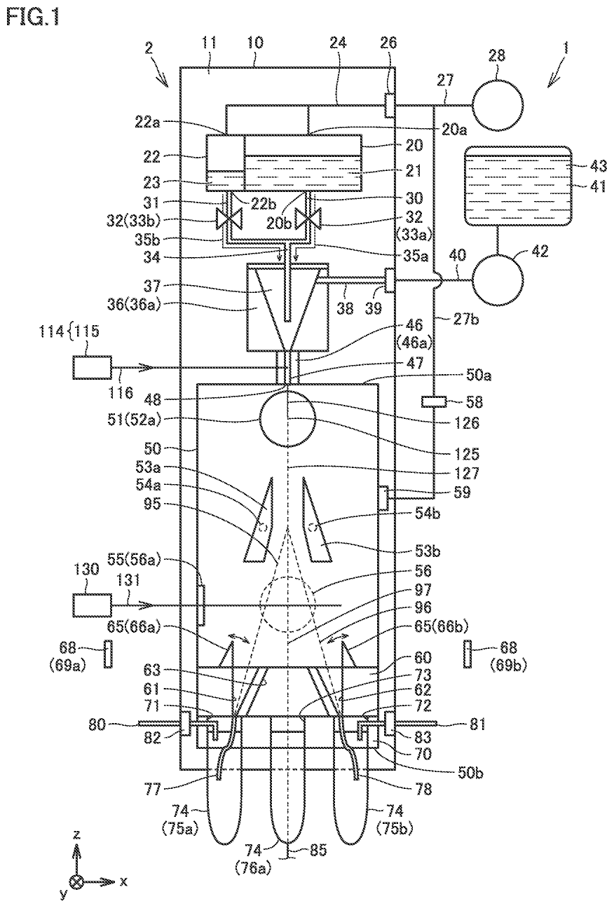

The following describes a particle sorting apparatus 1 according to a first embodiment with reference to FIGS. 1 to 4. Particle sorting apparatus 1 includes a cartridge 2 and a body 3.

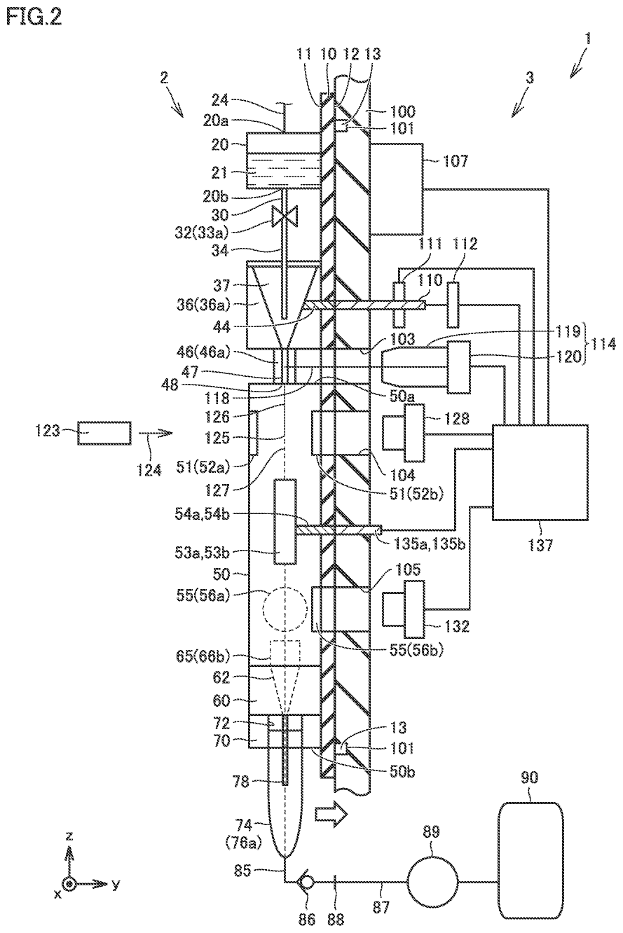

Cartridge 2 is attachable/detachable to/from body 3. As shown in FIG. 2, a pin 13 is provided on a second main surface 12 of a base plate 10 of cartridge 2 so as to protrude from second main surface 12. A recess 101 is provided in a movable plate 100 of body 3. Cartridge 2 is moved toward movable plate 100 of body 3 to fit pin 13 into recess 101. In this way, cartridge 2 is attached to body 3. By moving cartridge 2 away from movable plate 100 of body 3, cartridge 2 is detached from body 3.

### Configuration of Cartridge 2

Cartridge 2 includes base plate 10, a first reservoir 20, a sample liquid conduit 30, a first conduit 34, a second conduit 38, a mixer 36, a flow channel portion 46, a nozzle 48, deflection electrodes 53a, 53b, and a droplet collection member 74. Cartridge 2 further includes flow channel portion 46. Cartridge 2 further includes sterilization filters 26, 39, a check valve 86, and tubes 24, 85. Cartridge 2 further includes a second reservoir 22, a calibration liquid conduit 31, and a flow path switch 32. Cartridge 2 further includes a case 50 and a sterilization filter 59. Cartridge 2 further includes a droplet collection destination changeable member 65. Cartridge 2 further includes air vent tubes 80, 81 and sterilization filters 82, 83. Cartridge 2 further includes a first block 60, a first supporting block 70, and tubes 77, 78.

Base plate 10 of cartridge 2 includes a first main surface 11 and second main surface 12 opposite to first main surface 11. First reservoir 20, second reservoir 22, mixer 36, and case 50 are fixed on first main surface 11 of base plate 10. Flow channel portion 46 is fixed on first main surface 11 of base plate 10 with a supporting member (not shown) being interposed therebetween.

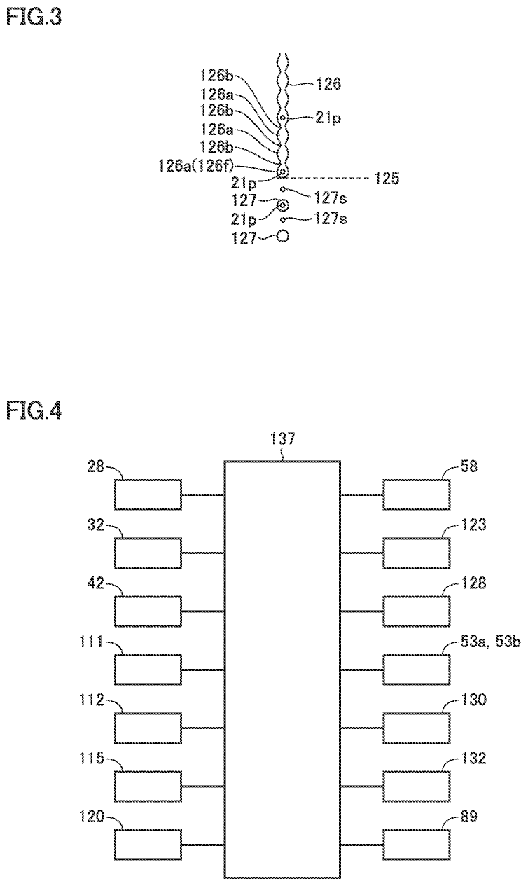

First reservoir 20 accommodates a sample liquid 21 including particles 21p (see FIG. 3). Examples of particles 21p included in sample liquid 21 include biological particles (such as cells or microorganisms) labeled with a fluorescent material such as a fluorescent dye and a fluorescent antibody. First reservoir 20 is provided with a first inlet 20a and a first outlet 20b. Second reservoir 22 includes a calibration liquid 23 including calibration beads (not shown). Examples of the calibration beads include fluorescent beads (for example, SPHERO™ Rainbow Calibration Particles RCP-30-5). Second reservoir 22 is provided with a second inlet 22a and a second outlet 22b.

Sterilization filter 26 is connected to first inlet 20a of first reservoir 20 and second inlet 22a of second reservoir 22. Specifically, tube 24 is airtightly connected to first inlet 20a of first reservoir 20 and second inlet 22a of second reservoir 22. Sterilization filter 26 is provided at tube 24. Each of sterilization filters 26, 39, 59, 82, 83 of the present embodiment is a filter that prevents passage of a fine particle having a diameter of more than or equal to 0.5 μm. The diameter of each of minute holes provided in each of sterilization filters 26, 39, 59, 82, 83 is, for example, less than or equal to 0.2 μm. Sample liquid 21 and calibration liquid 23 are fed with pressure by air supplied from a first pump 28 as described below.

Sample liquid conduit 30 is airtightly connected to first outlet 20b of first reservoir 20. Calibration liquid conduit 31 is airtightly connected to second outlet 22b of second reservoir 22. First conduit 34 allows sample liquid 21 or calibration liquid 23 to flow therethrough. Specifically, first conduit 34 is connected to sample liquid conduit 30 via valve 33a. First conduit 34 is connected to calibration liquid conduit 31 via valve 33b. First conduit 34 extends to an inner cavity 37 of mixer 36. First conduit 34 is airtightly connected to mixer 36.

Flow path switch 32 is switchable between a first flow path 35a extending from first outlet 20b of first reservoir 20 to mixer 36 and a second flow path 35b extending from second outlet 22b of second reservoir 22 to mixer 36. Specifically, first flow path 35a is constituted of sample liquid conduit 30 and first conduit 34. Second flow path 35b is constituted of calibration liquid conduit 31 and first conduit 34. Flow path switch 32 includes, for example, valves 33a, 33b. Valve 33a is airtightly connected to sample liquid conduit 30 and first conduit 34. Valve 33b is airtightly connected to calibration liquid conduit 31 and first conduit 34. When valve 33a is opened and valve 33b is closed, sample liquid 21 flows from first reservoir 20 to mixer 36 through sample liquid conduit 30 and first conduit 34. When valve 33b is opened and valve 33a is closed, calibration liquid 23 flows from second reservoir 22 to mixer 36 through calibration liquid conduit 31 and first conduit 34.

Mixer 36 is provided with inner cavity 37. Inner cavity 37 of mixer 36 is tapered in a direction toward the outlet of mixer 36. Mixer 36 is connected to first reservoir 20 via sample liquid conduit 30 and first conduit 34. Sample liquid 21 is supplied from first reservoir 20 to inner cavity 37 of mixer 36 through sample liquid conduit 30 and first conduit 34. Mixer 36 is connected to second reservoir 22 via calibration liquid conduit 31 and first conduit 34. Calibration liquid 23 is supplied from second reservoir 22 to inner cavity 37 of mixer 36 through calibration liquid conduit 31 and first conduit 34. Mixer 36 is connected to second conduit 38.

Second conduit 38 allows a sheath liquid 43 to flow therethrough. Specifically, second conduit 38 is connected to a sheath-liquid tank 41 via a tube 40 and second conduit 38. As described below, sheath liquid 43 is supplied from sheath-liquid tank 41 to inner cavity 37 of mixer 36 through tube 40 and second conduit 38. Sterilization filter 39 is provided at second conduit 38. Since sheath liquid 43 includes no calibration beads or no particles 21p, sterilization filter 39 is not clogged even though sterilization filter 39 is disposed in the flow path for sheath liquid 43. Therefore, sterilization filter 39 can be disposed in the flow path for sheath liquid 43. Sterilization filter 39 prevents fine particles included in sheath liquid 43 and having a diameter of more than or equal to 0.5 μm from entering inner cavity 37 of mixer 36.

When sorting particles 21p included in sample liquid 21, sample liquid 21 and sheath liquid 43 flow into inner cavity 37 of mixer 36. In mixer 36, a sheath flow in which sample liquid 21 is enclosed with sheath liquid 43 is formed. The sheath flow in which sample liquid 21 is enclosed with sheath liquid 43 is ejected from the outlet of mixer 36. In a first calibration step of a below-described calibration step (S3), calibration liquid 23 and sheath liquid 43 flow into inner cavity 37 of mixer 36. In mixer 36, a sheath flow in which calibration liquid 23 is enclosed with sheath liquid 43 is formed. The sheath flow in which calibration liquid 23 is enclosed with sheath liquid 43 is ejected from the outlet of mixer 36.

Mixer 36 is, for example, a chamber 36a. Inner cavity 37 of chamber 36a has, for example, a shape of inverted conical frustum. Inner cavity 37 of chamber 36a is formed by hollowing out a cylindrical member or a prismatic member. In a cross section perpendicular to a flow direction (z direction) of the sheath flow, chamber 36a has a circular or quadrangular shape, for example.

As shown in FIG. 2, mixer 36 includes a vibration electrode terminal 44. One end portion of vibration electrode terminal 44 is exposed to inner cavity 37 of mixer 36. The one end portion of vibration electrode terminal 44 may be flush with an inner surface of mixer 36 that defines inner cavity 37 of mixer 36. Accordingly, the sheath flow in inner cavity 37 of mixer 36 can be prevented from being disturbed by vibration electrode terminal 44. Vibration electrode terminal 44 extends through mixer 36 and base plate 10. Vibration electrode terminal 44 is airtightly attached to mixer 36. The other end of vibration electrode terminal 44 is exposed from second main surface 12 of base plate 10.

Flow channel portion 46 is airtightly connected to the outlet of mixer 36. Flow channel portion 46 is provided with a flow channel 47 in which the sheath flow in which sample liquid 21 or calibration liquid 23 is enclosed with sheath liquid 43 flows. Flow channel 47 communicates with inner cavity 37 of mixer 36. Flow channel portion 46 is composed of a material transparent to excitation light 116 emitted from first light source 115 and fluorescence or scattered light 118 emitted from each of particles 21p or the calibration beads flowing in flow channel 47. Flow channel portion 46 is composed of, for example, glass or a transparent resin. Flow channel portion 46 is, for example, a flow cell 46a. In flow cell 46a, flow channel 47 is formed in a cylindrical member or a prismatic member. In a cross section perpendicular to the flow direction (z direction) of the sheath flow, flow channel 47 has a quadrangular shape, for example.

Nozzle 48 communicates with inner cavity 37 of mixer 36. Specifically, flow channel 47 communicates with inner cavity 37 of mixer 36 and nozzle 48, and nozzle 48 communicates with inner cavity 37 of mixer 36 through flow channel 47. Nozzle 48 is integrated with flow channel portion 46 and may be the lower end of flow channel portion 46. Nozzle 48 may be an outlet of flow channel 47. The sheath flow is sent out from nozzle 48 as a jet flow 126.

Case 50 is disposed between mixer 36 and droplet collection member 74. Specifically, case 50 is disposed between flow channel portion 46 and droplet collection member 74. Case 50 includes an upper end 50a and a lower end 50b in the flow direction (z direction) of the sheath flow. Upper end 50a of case 50 is airtightly connected to flow channel portion 46. An upper opening is provided at a portion of upper end 50a of case 50 in conformity with flow channel 47. A lower opening is provided at lower end 50b of case 50. First block 60 and first supporting block 70 are inserted into case 50 via the lower opening of case 50 and are fitted into case 50. The outer side surface of first block 60 is airtightly connected to the inner surface of case 50. The outer side surface of first supporting block 70 is airtightly connected to the inner surface of case 50. An inner space of case 50 is formed between upper end 50a of case 50 and the upper end of first block 60. Case 50 isolates, from a surrounding environment around cartridge 2, jet flow 126 released from nozzle 48, a break-off point 125, droplets 127 and satellite drops 127s (see FIGS. 1 to 3). Break-off point 125 is the lower end portion of jet flow 126.

Deflection electrodes 53a, 53b are disposed in the inner space of case 50. Deflection electrodes 53a, 53b deflect each of droplets 127 released from nozzle 48. Specifically, by applying voltage between deflection electrodes 53a, 53b, a deflection electric field is formed between deflection electrodes 53a, 53b. The falling direction of droplet 127 is changed in accordance with the polarity and amount of charges supplied from a charge supply unit 112 of body 3 to droplet 127. In this way, a center stream 97 and side streams 95, 96 are formed. Center stream 97 is formed by droplets 127 not deflected by deflection electrodes 53a, 53b. Side streams 95, 96 are formed by droplets 127 deflected by deflection electrodes 53a, 53b. Deflection electrodes 53a, 53b include deflection electrode terminals 54a, 54b.

Case 50 includes a first transparent portion 51. First transparent portion 51 allows for observation of at least one of jet flow 126, break-off point 125, droplet 127, or satellite drop 127s. Particularly, first transparent portion 51 allows for observation of jet flow 126, break-off point 125, and droplet 127. Specifically, first transparent portion 51 includes transparent windows 52a, 52b. Transparent window 52a faces a strobe light 123 (see FIG. 2) of body 3. Transparent window 52b faces a first imaging element 128 (see FIG. 2) of body 3. Transparent windows 52a, 52b can permit passage of first illumination light 124 emitted from strobe light 123.

Case 50 includes a second transparent portion 55. Second transparent portion 55 allows for observation of side streams 95, 96 formed by deflected droplets 127. Specifically, second transparent portion 55 includes transparent windows 56a, 56b. Transparent window 56a faces a second light source 130 (see FIG. 1) of body 3. Transparent window 56b faces a second imaging element 132 (see FIG. 2) of body 3. Transparent window 56a can permit passage of second illumination light 131 emitted from second light source 130. Transparent window 56b can permit passage of second illumination light 131 scattered by side streams 95, 96.

Sterilization filter 59 is provided at a portion of case 50 connected to tube 27b. Sterilization filter 59 prevents a fine particle having a diameter of more than or equal to 0.5 μm from entering the inner space of case 50. Since air is supplied from the first pump into the inner space of case 50 through tubes 27, 27b, pressure in the inner space of case 50 is higher than the atmospheric pressure. Therefore, even though the diameter of the lower opening of each of a first funnel 61 and a second funnel 62 and the diameter of each of tubes 77, 78 are small, droplets 127 accumulated in first funnel 61 and second funnel 62 can be smoothly moved to deflected-droplet collection members 75a, 75b through tubes 77, 78.

As described below, due to a pressure reduction valve 58, the pressure in the inner space of case 50 is lower than the air pressure applied to sample liquid 21 in first reservoir 20 and calibration liquid 23 in second reservoir 22. Therefore, sample liquid 21 in first reservoir 20 and calibration liquid 23 in second reservoir 22 are released from nozzle 48 into the inner space of case 50.

First block 60 is provided with first funnel 61, second funnel 62, and a central opening 63. Central opening 63 is located on the path for non-deflected droplets 127. First funnel 61 and second funnel 62 are located on the paths for deflected droplets 127. First funnel 61 and second funnel 62 are disposed beside respective sides of central opening 63. Each of first funnel 61 and second funnel 62 is provided with: an upper opening close to nozzle 48 or case 50; and a lower opening close to droplet collection member 74. Each of first funnel 61 and second funnel 62 is tapered in a direction from the upper opening toward the lower opening.

Droplet collection destination changeable member 65 can change, between each of deflected-droplet collection members 75a, 75b and a waste-droplet collection member 76a, a collection destination for each of droplets 127 released from nozzle 48 and deflected. Droplet collection destination changeable member 65 includes a first cover 66a and a second cover 66b, for example. First cover 66a and second cover 66b are attached to first block 60. First cover 66a can open and close the upper opening of first funnel 61. Second cover 66b can open and close the upper opening of second funnel 62.

When first cover 66a opens the upper opening of first funnel 61, deflected droplet 127 is collected in deflected-droplet collection member 75a. When second cover 66b opens the upper opening of second funnel 62, deflected droplet 127 is collected in deflected-droplet collection member 75b. When first cover 66a closes the upper opening of first funnel 61, deflected droplet 127 is collected in waste-droplet collection member 76a. When second cover 66b closes the upper opening of second funnel 62, deflected droplet 127 is collected in waste-droplet collection member 76a. In this way, first cover 66a and second cover 66b can change, between a corresponding one of deflected-droplet collection members 75a, 75b and waste-droplet collection member 76a, the collection destination for droplet 127 released from nozzle 48 and deflected.

First supporting block 70 is located further away from nozzle 48 with respect to first block 60. First supporting block 70 supports droplet collection member 74. Specifically, first supporting block 70 is provided with through holes 71, 72, 73. Deflected-droplet collection member 75a is fitted into through hole 71. Deflected-droplet collection member 75a is fitted into through hole 72. Through holes 71, 72 are fluidically separated from central opening 63 of first block 60. Waste-droplet collection member 76a is fitted into through hole 73. Through hole 73 communicates with central opening 63 of first block 60. Deflected-droplet collection members 75a, 75b and waste-droplet collection member 76a are airtightly connected to first supporting block 70.

Droplet collection member 74 can collect droplets 127 released from nozzle 48. Droplet collection member 74 includes waste-droplet collection member 76a and deflected-droplet collection members 75a, 75b. Waste-droplet collection member 76a collects droplets 127 in the calibration step (see FIG. 5) and collects droplets 127 that form center stream 97 in a particle sorting step (see FIG. 5), for example. Deflected-droplet collection members 75a, 75b collect droplets 127 that form side streams 95, 96 in the particle sorting step (see FIG. 5), for example.

Specifically, deflected-droplet collection member 75a communicates with the lower opening of first funnel 61 through tube 77. Deflected-droplet collection member 75b communicates with the lower opening of second funnel 62 through tube 78. Each of the diameter of the lower opening of first funnel 61 and the diameter of tube 77 is smaller than the upper opening of deflected-droplet collection member 75a. Each of the diameter of the lower opening of second funnel 62 and the diameter of tube 78 is smaller than the upper opening of deflected-droplet collection member 75b. Therefore, when detaching cartridge 2 from body 3 after sorting particles 21p included in sample liquid 21, and when transporting cartridge 2 to a safety cabinet after sorting particles 21p included in sample liquid 21, sorted particles 21p can be prevented from leaking from deflected-droplet collection members 75a, 75b.

As shown in FIG. 2, check valve 86 is connected to waste-droplet collection member 76a. Specifically, tube 85 is connected to waste-droplet collection member 76a. Check valve 86 is provided at tube 85. Check valve 86, rather than a sterilization filter, is provided in a waste-liquid flow path extending from waste-droplet collection member 76a to a waste-liquid tank 90. Therefore, even when the calibration beads or the like are included in waste-droplet collection member 76a, check valve 86 is not clogged. The calibration beads or the like collected in waste-droplet collection member 76a can be also ejected to waste-liquid tank 90 through check valve 86.

Specifically, when a third pump 89 of body 3 is being operated, check valve 86 is opened. Check valve 86 permits the waste liquid including droplets 127 collected in waste-droplet collection member 76a to flow to outside of cartridge 2 through tube 85. The waste liquid accumulated in waste-droplet collection member 76a is ejected to waste-liquid tank 90 through check valve 86. On the other hand, when third pump 89 of body 3 is not being operated, check valve 86 is closed. Check valve 86 prevents the waste liquid in waste-liquid tank 90 of body 3 and fine particles each having a diameter of more than or equal to 0.5 μm from entering waste-droplet collection member 76a through tube 85. When check valve 86 is closed, check valve 86 can isolate below-described sample liquid flow path and sheath liquid flow path from the surrounding environment around cartridge 2 and can maintain the sample liquid flow path and the sheath liquid flow path in the sterile state.

Air vent tubes 80, 81 are connected to deflected-droplet collection members 75a, 75b. Air vent tubes 80, 81 allow air in deflected-droplet collection members 75a, 75b to be exhausted to the surrounding environment around cartridge 2 when droplets 127 including particles 21p are accumulated in deflected-droplet collection members 75a, 75b. Even when deflected droplets 127 are accumulated in deflected-droplet collection members 75a, 75b, air vent tubes 80, 81 can prevent increased air pressure in deflected-droplet collection members 75a, 75b. Sterilization filters 82, 83 are provided at air vent tubes 80, 81. Sterilization filters 82, 83 prevent fine particles each having a diameter of more than or equal to 0.5 μm from entering deflected-droplet collection members 75a, 75b from the surrounding environment around cartridge 2.

The sample liquid flow path and the sheath liquid flow path are isolated from the surrounding environment around cartridge 2 and are maintained in the sterile state. The sample liquid flow path extends from first reservoir 20 to droplet collection member 74. The sheath liquid flow path extends from sterilization filter 39 to droplet collection member 74. In the present specification, the sterile state means that the number of fine particles each having a diameter of more than or equal to 0.5 μm per air volume of 1.0 m³ is less than or equal to 3520 (Grade A (ISO5)). Specifically, sterilization filters 26, 39 and check valve 86 can isolate the sample liquid flow path and the sheath liquid flow path from the surrounding environment around cartridge 2 and can maintain the sample liquid flow path and the sheath liquid flow path in the sterile state.

Specifically, the sample liquid flow path, the sheath liquid flow path, and the calibration liquid flow path are isolated from the surrounding environment around cartridge 2 and are maintained in the sterile state. The calibration liquid flow path extends from second reservoir 22 to droplet collection member 74. Specifically, sterilization filters 26, 39 and check valve 86 can isolate the sample liquid flow path, the sheath liquid flow path, and the calibration liquid flow path from the surrounding environment around cartridge 2, and can maintain the sample liquid flow path, the sheath liquid flow path, and the calibration liquid flow path in the sterile state.

### Configuration of Body 3

Referring to FIGS. 1 and 2, body 3 includes a housing (not shown), movable plate 100 (see FIG. 2) movable with respect to the housing, an optical system 114, and a moving mechanism 107. Movable plate 100 is an insulating resin substrate, for example. Body 3 further includes a vibration electrode 110, a vibration element 111, charge supply unit 112, strobe light 123, first imaging element 128, electrode terminals 135a, 135b, second light source 130, second imaging element 132, and a controller 137. Body 3 includes tubes 27, 27b, 40, 87, first pump 28, sheath-liquid tank 41, a second pump 42, pressure reduction valve 58, third pump 89, and waste-liquid tank 90. Body 3 includes a driving unit 68 (see FIG. 1).

Optical system 114, charge supply unit 112, strobe light 123, first imaging element 128, second light source 130, second imaging element 132, controller 137, first pump 28, sheath-liquid tank 41, second pump 42, pressure reduction valve 58, third pump 89, and waste-liquid tank 90 are fixed to the housing (not shown) of body 3. Moving mechanism 107 is fixed to movable plate 100 and the housing of body 3. Vibration electrode 110 and electrode terminals 135a, 135b are fixed to movable plate 100. Vibration element 111 is fixed to vibration electrode 110.

As shown in FIG. 1, tube 27 is connected to first pump 28. Tube 27 is connected to tube 24 via sterilization filter 26. First pump 28 supplies air toward sample liquid 21 in first reservoir 20 and calibration liquid 23 in second reservoir 22 through tubes 24, 27 and sterilization filter 26. Sample liquid 21 in first reservoir 20 and calibration liquid 23 in second reservoir 22 are fed with pressure by the air supplied from first pump 28.

Tube 27b is connected to tube 27. Tube 27b is connected to case 50 via sterilization filter 59. First pump 28 supplies air toward the inner space of case 50 through tubes 27, 27b and sterilization filter 59. The inner space of case 50 is fed with pressure by the air supplied from first pump 28. Therefore, the pressure in the inner space of case 50 is higher than the atmospheric pressure. Pressure reduction valve 58 is provided at tube 27b. Pressure reduction valve 58 causes the pressure of the air on the outlet side of pressure reduction valve 58 to be lower than the pressure of the air on the inlet side of the pressure reduction valve. Therefore, the pressure in the inner space of case 50 is lower than the air pressure applied to each of sample liquid 21 in first reservoir 20 and calibration liquid 23 in second reservoir 22.

Sheath liquid 43 is stored in sheath-liquid tank 41. Tube 40 is connected to sheath-liquid tank 41. Tube 40 is connected to second conduit 38 via sterilization filter 39. Second pump 42 is provided at tube 40. Second pump 42 causes sheath liquid 43 stored in sheath-liquid tank 41 to flow to second conduit 38.

Referring to FIG. 2, moving mechanism 107 can move one of cartridge 2 and optical system 114 with respect to the other of cartridge 2 and optical system 114. In one example, moving mechanism 107 can move cartridge 2 with respect to optical system 114. Specifically, since base plate 10 of cartridge 2 is attached to movable plate 100 of body 3, cartridge 2 is movable together with movable plate 100. Moving mechanism 107 moves movable plate 100 of body 3 with respect to the housing (not shown) of body 3 to move base plate 10 of cartridge 2 with respect to the housing of body 3. Optical system 114 is fixed to the housing (not shown) of body 3. Thus, moving mechanism 107 can move cartridge 2 with respect to optical system 114. Moving mechanism 107 is, for example, a triaxial moving mechanism, and can move cartridge 2 in the first direction (z direction), the second direction (x direction), and the third direction (y direction). Moving mechanism 107 may further rotate cartridge 2 within first main surface 11 (xz plane) of base plate 10 with respect to the optical axis of an optical detection system 119 (fluorescence or scattered light 118).

As shown in FIGS. 1 and 2, optical system 114 includes first light source 115 and optical detector 120. Optical system 114 may further include optical detection system 119. First light source 115 can emit excitation light 116 toward flow channel 47. First light source 115 is, for example, a laser light source, and excitation light 116 is, for example, a laser beam. Particles 21p or the calibration beads flowing in flow channel 47 are irradiated with excitation light 116. Fluorescent or scattered light 118 is generated from particles 21p or the calibration beads.

Fluorescence or scattered light 118 generated from particles 21p or the calibration beads enters optical detection system 119 through a hole 103 provided in movable plate 100. Optical detection system 119 guides, to optical detector 120, fluorescence or scattered light 118 generated from particles 21p or the calibration beads. Optical detection system 119 includes, for example, at least one of a lens, a wavelength filter, or an optical fiber. Optical detector 120 can detect fluorescence or scattered light 118 emitted from particles 21p or the calibration beads. Optical detector 120 is, for example, a photomultiplier tube (PMT) or a photodiode. By analyzing, by controller 137, fluorescence or scattered light 118 detected by optical detector 120, identification information of particle 21p included in sample liquid 21 is obtained.

As shown in FIG. 2, vibration electrode 110 extends through movable plate 100. One end of vibration electrode 110 is exposed from the main surface of movable plate 100 facing second main surface 12 of cartridge 2. When cartridge 2 is attached to body 3, vibration electrode 110 is brought into contact with vibration electrode terminal 44 of cartridge 2 and is electrically connected to vibration electrode terminal 44.

Vibration element 111 is coupled to vibration electrode 110. For example, vibration element 111 has a ring shape, and vibration electrode 110 is fitted in the hole of vibration element 111. Vibration element 111 is, for example, a piezoelectric element. Ultrasonic vibration of vibration element 111 is transmitted to the sheath flow in inner cavity 37 of mixer 36 via vibration electrode 110 and vibration electrode terminal 44. Jet flow 126 is sent out from nozzle 48. The ultrasonic vibration generated by vibration element 111 is transmitted to jet flow 126. Therefore, droplet 127 is separated from jet flow 126 at break-off point 125, which is the lower end portion of jet flow 126. Each droplet 127 includes, for example, one particle 21p at maximum (see FIG. 3).

As shown in FIG. 3, jet flow 126 includes jet flow droplets 126a and constriction portions 126b. In jet flow 126, adjacent jet flow droplets 126a are connected to each other at a constriction portion 126b. Each of jet flow droplets 126a is a droplet included in jet flow 126 before being separated into droplet 127. Parts of jet flow droplets 126a include particles 21p. Each of constriction portions 126b includes no particle 21p. Jet flow droplet 126a closest to break-off point 125 in jet flow 126 is a final jet flow droplet 126f. Each of satellite drops 127s has a size smaller than that of droplet 127 and includes no particle 21p.

As shown in FIG. 2, charge supply unit 112 is connected to vibration electrode 110 by using, for example, an electric wiring. Charge supply unit 112 supplies charges to droplet 127 via vibration electrode 110, vibration electrode terminal 44, the sheath flow, and jet flow 126. Specifically, charge supply unit 112 changes the polarity and amount of charges to be supplied to droplet 127 in accordance with the identification information of particle 21p included in droplet 127.

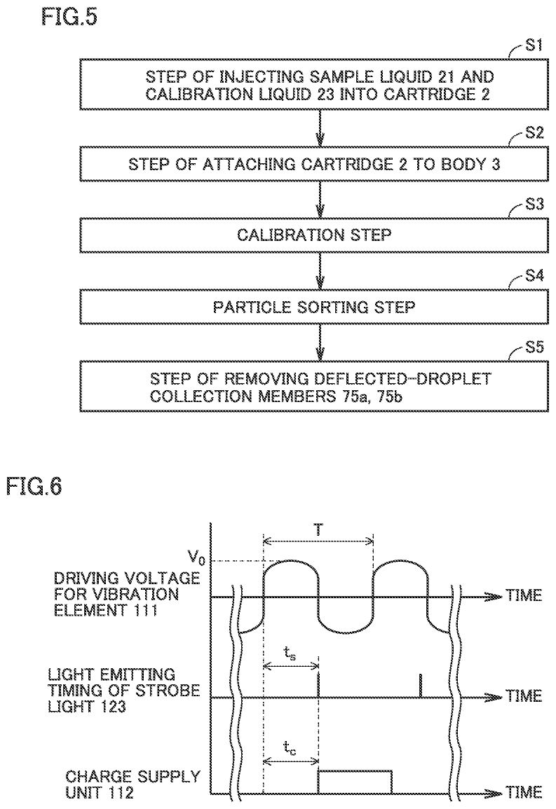

Strobe light 123 emits first illumination light 124. In one example, a timing is at which strobe light 123 emits light (see FIG. 6) is synchronized with a timing t_{c} at which the charges are started to be supplied to final jet flow droplet 126f (see FIG. 6). Strobe light 123 can illuminate at least one of jet flow 126, droplet 127 separated from jet flow 126, or satellite drop 127s. Particularly, strobe light 123 illuminates jet flow 126, droplet 127, and satellite drop 127s. Strobe light 123 is, for example, an LED lamp.

First imaging element 128 can obtain an image of at least one of jet flow 126, droplet 127, or satellite drop 127s through transparent window 52b and a hole 104 provided in movable plate 100. Particularly, first imaging element 128 obtains an image of jet flow 126, droplet 127, and satellite drop 127s. The image obtained by first imaging element 128 may include an image of break-off point 125. First imaging element 128 is, for example, a CCD camera or a CMOS camera.

Electrode terminals 135a, 135b extend through movable plate 100. One end of electrode terminal 135a and one end of electrode terminal 135b are exposed from the main surface of movable plate 100 facing second main surface 12 of cartridge 2. When cartridge 2 is attached to body 3, electrode terminal 135a is brought into contact with deflection electrode terminal 54a and is electrically connected to deflection electrode terminal 54a, and electrode terminal 135b is brought into contact with deflection electrode terminal 54b and is electrically connected to deflection electrode terminal 54b.

As shown in FIG. 1, second light source 130 can emit second illumination light 131 toward side streams 95, 96. Second light source 130 is, for example, a laser or a lamp. When each of side streams 95, 96 is irradiated with the second illumination light, scattered light is generated in each of side streams 95, 96.

As shown in FIG. 2, second imaging element 132 can image the scattered light from each of side streams 95, 96 through transparent window 56b and a hole 105 provided in movable plate 100. A degree of variation of each of side streams 95, 96 can be found from the image obtained by second imaging element 132. Second imaging element 132 is, for example, a CCD camera or a CMOS camera.

As shown in FIG. 1, driving unit 68 can drive droplet collection destination changeable member 65 of cartridge 2. Driving unit 68 includes a first movable magnet 69a and a second movable magnet 69b, for example. Each of first cover 66a and second cover 66b is composed of, for example, a magnetic material. By moving first movable magnet 69a, the upper opening of first funnel 61 is opened/closed by first cover 66a. By moving second movable magnet 69b, the upper opening of second funnel 62 is opened/closed by second cover 66b. First movable magnet 69a and second movable magnet 69b may be manually moved or may be moved using an actuator (not shown). An operation of the actuator may be controlled by controller 137.

As shown in FIG. 2, waste-liquid tank 90 is connected to tube 87. When cartridge 2 is attached to body 3, tube 85 of cartridge 2 is connected to tube 87 at a tube connection portion 88. Third pump 89 is provided at tube 87. Third pump 89 is, for example, a decompression pump or a suction pump. When third pump 89 is not being operated, check valve 86 is closed, thereby preventing particles each having a diameter of more than or equal to 0.5 μm from entering waste-droplet collection member 76a from the surrounding environment around cartridge 2. When third pump 89 is being operated, check valve 86 is opened, and the waste liquid accumulated in waste-droplet collection member 76a is suctioned. The waste liquid accumulated in waste-droplet collection member 76a is ejected to waste-liquid tank 90 through check valve 86. Waste-liquid tank 90 stores the waste liquid.

As shown in FIGS. 2 and 4, controller 137 is communicatively connected to first pump 28, flow path switch 32, second pump 42, vibration element 111, charge supply unit 112, first light source 115, optical detector 120, pressure reduction valve 58, strobe light 123, first imaging element 128, deflection electrodes 53a, 53b, second light source 130, second imaging element 132, and third pump 89. Controller 137 controls first pump 28, flow path switch 32, second pump 42, vibration element 111, charge supply unit 112, first light source 115, pressure reduction valve 58, deflection electrodes 53a, 53b, second light source 130, strobe light 123, and third pump 89. Controller 137 can be implemented by a processor (arithmetic processing unit) such as a CPU, for example.

Controller 137 analyzes fluorescence or scattered light 118 measured by optical detector 120 so as to obtain the identification information of particle 21p. Controller 137 controls an amplitude V₀ (see FIG. 6) or frequency of a driving voltage to be applied to vibration element 111. In this way, the amplitude or frequency of vibration (for example, ultrasonic vibration) to be supplied from vibration element 111 to jet flow 126 is controlled. One droplet 127 is generated in one cycle T of vibration (see FIG. 6). By changing the frequency of vibration to be supplied from vibration element 111 to jet flow 126, the number of droplets 127 generated per unit time is changed, thereby changing the number of particles sorted per unit time. Controller 137 controls the magnitude of an electric field to be applied between deflection electrodes 53a, 53b.

Controller 137 controls charge supply unit 112. Specifically, controller 137 controls the polarity and amount of charges to be supplied from charge supply unit 112 to droplet 127 (final jet flow droplet 126f) in accordance with the identification information of particle 21p. Controller 137 changes timing t_{c} (see FIG. 6) at which the charges are started to be supplied from charge supply unit 112 to final jet flow droplet 126f in one cycle T (see FIG. 6) of vibration of vibration element 111. By changing timing t_{c}, the state of jet flow 126, droplet 127, or satellite drop 127s at timing t_{c} can be changed.

Controller 137 controls light emission timing is (see FIG. 6) of strobe light 123 in one cycle T of vibration of vibration element 111. Controller 137 controls strobe light 123 such that, for example, light emission timing is of strobe light 123 in one cycle T of vibration of vibration element 111 is synchronized with timing t_{c} at which the charges are started to be supplied from charge supply unit 112 to final jet flow droplet 126f in one cycle T of vibration of vibration element 111.

Controller 137 processes the image obtained by first imaging element 128. Based on a feature amount of at least one of jet flow 126, droplet 127, or satellite drop 127s included in the image obtained by first imaging element 128, controller 137 adjusts timing t_{c} (see FIG. 6) or amplitude V₀ (see FIG. 6) of the driving voltage to be applied to vibration element 111, so as to cause variation of each of side streams 95, 96 to fall within a reference range. The feature amount includes, for example, at least one of the length, width, perimeter, or area of final jet flow droplet 126f

### Particle Sorting Method

A particle sorting method according to the first embodiment will be described with reference to FIG. 5.

### Step (S1) of Injecting Sample Liquid 21 and Calibration Liquid 23 into Cartridge 2

Cartridge 2 is placed in a sterilization packaging bag (not shown). The sterilization packaging bag isolates cartridge 2 from the surrounding environment around cartridge 2. Cartridge 2 is irradiated with gamma rays to sterilize cartridge 2. Cartridge 2 in the sterilization packaging bag is placed in a safety cabinet (not shown) installed in a working area in a cell processing center (CPC). A degree of air cleanliness of the working area is of Grade A (ISO5), and the working area is maintained in a sterile environment. In the present specification, the sterile environment means an environment in which the number of fine particles each having a diameter of more than or equal to 0.5 μm is less than or equal to 3520 per air volume of 1.0 m³.

Cartridge 2 is removed from the sterilization packaging bag in the safety cabinet. In the safety cabinet, sample liquid 21 is injected into cartridge 2. Specifically, valve 33a is closed. Sample liquid 21 including particles 21p is injected into first reservoir 20 via first inlet 20a of first reservoir 20. In the safety cabinet, calibration liquid 23 is injected into cartridge 2. Specifically, valve 33b is closed. Calibration liquid 23 including the calibration beads is injected into second reservoir 22 via second inlet 22a of second reservoir 22. Tube 24 connected to sterilization filter 26 is connected to first inlet 20a of first reservoir 20 and second inlet 22a of second reservoir 22. In this way, sample liquid 21 and calibration liquid 23 are injected into cartridge 2.

### Step (S2) of Attaching Cartridge 2 to Body 3

Cartridge 2 is attached to body 3. Specifically, cartridge 2 is removed from the safety cabinet. The sample liquid flow path, the calibration liquid flow path, and the sheath liquid flow path are isolated from the surrounding environment around cartridge 2 by sterilization filters 26, 39, 59, 82, 83 and check valves 86, and the sample liquid flow path, the calibration liquid flow path, and the sheath liquid flow path are maintained in the sterile state. Cartridge 2 is moved toward movable plate 100 of body 3. Pin 13 provided on base plate 10 of cartridge 2 is inserted into recess 101 provided in movable plate 100. In this way, cartridge 2 is attached to movable plate 100 of body 3.

Tube 27 is connected to sterilization filter 26. Tube 27b is connected to sterilization filter 59. Tube 40 is connected to sterilization filter 39. Vibration electrode terminal 44 of mixer 36 is connected to vibration electrode 110 of body 3. Deflection electrode terminals 54a, 54b of deflection electrodes 53a, 53b are connected to electrode terminals 135a, 135b of body 3. Tube 85 of cartridge 2 is connected to tube 87 at tube connection portion 88.

Flow channel portion 46 of cartridge 2 faces optical detection system 119. Transparent window 52a of case 50 of cartridge 2 faces strobe light 123. Transparent window 52b of case 50 of cartridge 2 faces first imaging element 128 of body 3. Transparent window 56a of case 50 of cartridge 2 faces second light source 130 of body 3. Transparent window 56b of case 50 of cartridge 2 faces second imaging element 132 of body 3.

### Calibration Step (S3)

The calibration step (S3) includes a first calibration step and a second calibration step.

### First Calibration Step

By moving one of cartridge 2 and optical system 114 of body 3 with respect to the other of cartridge 2 and optical system 114 of body 3, the one of cartridge 2 and optical system 114 of body 3 is aligned with the other of cartridge 2 and optical system 114 of body 3. For example, by moving cartridge 2 with respect to optical system 114 of body 3, cartridge 2 is aligned with optical system 114 of body 3.

Specifically, first pump 28, second pump 42, and third pump 89 are operated. Sheath liquid 43 is supplied from sheath-liquid tank 41 to mixer 36. Vibration element 111 is operated. Valve 33b is opened with valve 33a remaining closed. In this way, calibration liquid 23 including the calibration beads and sheath liquid 43 are supplied to mixer 36. The sheath flow in which calibration liquid 23 is enclosed with sheath liquid 43 is ejected from mixer 36. The sheath flow flows in flow channel 47 of flow channel portion 46. Excitation light 116 is emitted from first light source 115 to flow channel 47. When the calibration beads flowing in flow channel 47 are irradiated with excitation light 116, fluorescence or scattered light 118 is generated from the calibration beads.

Fluorescence or scattered light 118 enters optical detector 120 through optical detection system 119. Optical detector 120 detects fluorescence or scattered light 118. Moving mechanism 107 moves cartridge 2 with respect to optical system 114 to attain the maximum intensity of fluorescence or scattered light 118 detected by optical detector 120. Specifically, moving mechanism 107 moves movable plate 100. Since cartridge 2 is attached to movable plate 100, cartridge 2 can be moved together with movable plate 100. Optical system 114 is fixed to the housing (not shown) of body 3. Therefore, cartridge 2 can be moved with respect to optical system 114 by using moving mechanism 107. In this way, cartridge 2 is aligned with optical system 114 of body 3. The operation of moving mechanism 107 is controlled by controller 137.

Jet flow 126 is sent out from nozzle 48. The ultrasonic vibration generated by vibration element 111 is transmitted to jet flow 126. At break-off point 125, which is the lower end portion of jet flow 126, droplet 127 is separated from jet flow 126. In the first calibration step, droplet 127 is constituted of calibration liquid 23 and sheath liquid 43. Droplet 127 includes one calibration bead at maximum, for example. Droplet 127 includes no particle 21p.

In the first calibration step, charge supply unit 112 is not operated and no deflection electric field is formed between deflection electrodes 53a, 53b. In the first calibration step, no deflected droplet 127 exists, and calibration liquid 23 and sheath liquid 43 are all collected in waste-droplet collection member 76a. Therefore, in the first calibration step, first cover 66a may open the upper opening of first funnel 61, and second cover 66b may open the upper opening of second funnel 62. In order to prevent spray of calibration liquid 23 and sheath liquid 43 from entering deflected-droplet collection members 75a, 75b, first cover 66a may close the upper opening of first funnel 61 and second cover 66b may close the upper opening of second funnel 62 in the first calibration step. First cover 66a is operated by first movable magnet 69a, and second cover 66b is operated by second movable magnet 69b.

Since third pump 89 is being operated, check valve 86 is opened, and calibration liquid 23 and sheath liquid 43 accumulated in waste-droplet collection member 76a are suctioned by third pump 89. Calibration liquid 23 and sheath liquid 43 accumulated in waste-droplet collection member 76a are ejected to waste-liquid tank 90 through check valve 86. Check valve 86, rather than a sterilization filter, is provided in the waste-liquid flow path extending from waste-droplet collection member 76a to waste-liquid tank 90. Therefore, the calibration beads included in sheath liquid 43 are also ejected to waste-liquid tank 90 through check valve 86.

### Second Calibration Step

In the second calibration step, timing t_{c} (see FIG. 6) at which the charges are started to be supplied from charge supply unit 112 to final jet flow droplet 126f in one cycle T of vibration of vibration element 111, or amplitude V₀ (see FIG. 6) of the driving voltage to be applied to vibration element 111 is adjusted.

Specifically, in the second calibration step, droplet collection destination changeable member 65 is set such that the collection destination for droplet 127 released from nozzle 48 and deflected is waste-droplet collection member 76a. First cover 66a closes the upper opening of first funnel 61. Second cover 66b closes the upper opening of second funnel 62. First cover 66a is operated by first movable magnet 69a, and second cover 66b is operated by second movable magnet 69b.

First pump 28, second pump 42, and third pump 89 have been continuously operated since the first calibration step. Sheath liquid 43 has been continuously supplied to mixer 36. Valve 33b is closed with valve 33a remaining closed. In this way, only sheath liquid 43 is supplied to mixer 36 in the second calibration step. Vibration element 111 has been continuously operated since the first calibration step. The ultrasonic vibration has been continuously applied from vibration element 111 to sheath liquid 43 via vibration electrode 110 and vibration electrode terminal 44. Jet flow 126 is sent out from nozzle 48. The ultrasonic vibration generated by vibration element 111 is transmitted to jet flow 126. At break-off point 125, which is the lower end portion of jet flow 126, droplet 127 is separated from jet flow 126. In the second calibration step, droplet 127 is constituted of sheath liquid 43. Droplet 127 includes no calibration bead and no particle 21p.

Charge supply unit 112 is operated. Test charges are supplied from charge supply unit 112 to droplet 127 (final jet flow droplet 126f) via vibration electrode 110, vibration electrode terminal 44, sheath liquid 43, and jet flow 126. Voltage is applied between deflection electrodes 53a, 53b. A deflection electric field is formed between deflection electrodes 53a, 53b. Droplet 127 fed with the test charges is deflected by the deflection electric field. Deflected droplets 127 form side streams 95, 96.

Second light source 130 is operated. Second light source 130 emits second illumination light 131 toward side streams 95, 96. When side streams 95, 96 are irradiated with the second illumination light, scattered light is generated in each of side streams 95, 96. Second imaging element 132 images the scattered light from each of side streams 95, 96 through transparent window 56b and hole 105 provided in movable plate 100. A degree of variation of each of side streams 95, 96 can be found from the image obtained by second imaging element 132. Timing t_{c} (see FIG. 6) at which the charges are started to be supplied from charge supply unit 112 to final jet flow droplet 126f in one cycle T of vibration of vibration element 111, or amplitude V₀ (see FIG. 6) of the driving voltage to be applied to vibration element 111 is controlled to cause the variation of each of side streams 95, 96 to fall within a reference range.

In the second calibration step, each of droplets 127 that form side streams 95, 96 is constituted of sheath liquid 43. Each of droplets 127 that form side streams 95, 96 in the second calibration step includes no particle 21p included in sample liquid 21. As described above, in the second calibration step, droplet collection destination changeable member 65 is set such that the collection destination for droplets 127 released from nozzle 48 and deflected is waste-droplet collection member 76a. Specifically, first cover 66a closes the upper opening of first funnel 61. Second cover 66b closes the upper opening of second funnel 62. Therefore, droplets 127 deflected in the second calibration step can be prevented from being collected in deflected-droplet collection members 75a, 75b.

Droplets 127 deflected in the second calibration step are collected in waste-droplet collection member 76a through central opening 63 of first block 60. Since third pump 89 is being operated, check valve 86 is opened, and sheath liquid 43 accumulated in waste-droplet collection member 76a is suctioned by third pump 89. Sheath liquid 43 accumulated in waste-droplet collection member 76a is ejected to waste-liquid tank 90 through check valve 86.

Although the second calibration step is performed after performing the first calibration step in the present embodiment, the first calibration step may be performed after performing the second calibration step.

### Particle Sorting Step (S4)

A step of sorting particles 21p included in sample liquid 21 in accordance with types of particles 21p is performed.

Specifically, in the particle sorting step (S4), droplet collection destination changeable member 65 is set such that the collection destinations for droplets 127 released from nozzle 48 and deflected are deflected-droplet collection members 75a, 75b. First cover 66a opens the upper opening of first funnel 61. Second cover 66b opens the upper opening of second funnel 62. First cover 66a is operated by first movable magnet 69a, and second cover 66b is operated by second movable magnet 69b.

First pump 28, second pump 42, and third pump 89 has been continuously operated since the calibration step (S3). Sheath liquid 43 has been continuously supplied to mixer 36. Valve 33a is opened with valve 33b remaining closed. In this way, sample liquid 21 including particles 21p and sheath liquid 43 are supplied to mixer 36. The sheath flow in which sample liquid 21 is enclosed with sheath liquid 43 is ejected from mixer 36. The sheath flow flows in flow channel 47 of flow channel portion 46. Jet flow 126 is sent out from nozzle 48.

Vibration element 111 has been continuously operated since the calibration step (S3). Ultrasonic vibration is applied from vibration element 111 to sheath liquid 43 via vibration electrode 110 and vibration electrode terminal 44. The ultrasonic vibration generated by vibration element 111 is transmitted to jet flow 126. At break-off point 125, which is the lower end portion of jet flow 126, droplet 127 is separated from jet flow 126. In the particle sorting step (S4), droplet 127 is constituted of sample liquid 21 and sheath liquid 43. Each of droplets 127 includes one particle 21p at maximum, for example.

First light source 115 is operated. First light source 115 emits excitation light 116 toward flow channel 47. When each of particles 21p flowing in flow channel 47 is irradiated with excitation light 116, fluorescence or scattered light 118 is generated from particle 21p. Fluorescence or scattered light 118 enters optical detector 120 through optical detection system 119. Optical detector 120 detects fluorescence or scattered light 118. The wavelength or intensity of fluorescence or scattered light 118 detected by optical detector 120 differs depending on the type of each particle 21p. Identification information of particle 21p is obtained from the wavelength or intensity of fluorescence or scattered light 118 detected by optical detector 120.

Via vibration electrode 110, vibration electrode terminal 44, the sheath flow, and jet flow 126, charge supply unit 112 supplies droplet 127 (final jet flow droplet 126f) with charges corresponding to the identification information of particle 21p included in droplet 127 (final jet flow droplet 126f). Specifically, charge supply unit 112 changes the polarity and amount of charges to be supplied to droplet 127 (final jet flow droplet 126f) in accordance with the identification information of particle 21p included in droplet 127 (final jet flow droplet 126f).

For example, when particle 21p included in droplet 127 (final jet flow droplet 126f) is a first particle, positive charges are supplied to droplet 127 (final jet flow droplet 126f). When particle 21p included in droplet 127 (final jet flow droplet 126f) is a second particle that is different in type from the first particle, negative charges are supplied to droplet 127 (final jet flow droplet 126f). When droplet 127 includes no particle 21p or when particle 21p included in droplet 127 (final jet flow droplet 126f) is a third particle that is different in type from the first particle and the second particle, no charge is supplied to droplet 127 (final jet flow droplet 126f). The third particle is a particle that does not need to be sorted among particles 21p.

The deflection electric field is formed between deflection electrodes 53a, 53b. The deflection electric field changes a traveling direction (deflection direction) of droplet 127 in accordance with the polarity and amount of charges supplied to droplet 127. For example, when particle 21p included in droplet 127 is the first particle, droplet 127 is positively charged and therefore travels toward deflected-droplet collection member 75a. When particle 21p included in droplet 127 is the second particle, droplet 127 is negatively charged and therefore travels toward deflected-droplet collection member 75b. When no particle 21p is included in droplet 127 or when particle 21p included in droplet 127 (final jet flow droplet 126f) is the third particle, droplet 127 is not charged and therefore travels toward waste-droplet collection member 76a.

As described above, droplet collection destination changeable member 65 is set such that the collection destinations for droplets 127 released from nozzles 48 and deflected are deflected-droplet collection members 75a, 75b. Specifically, first cover 66a opens the upper opening of first funnel 61. Second cover 66b opens the upper opening of second funnel 62. Therefore, deflected droplets 127 are collected in deflected-droplet collection members 75a, 75b. In this way, particles 21p can be sorted in accordance with the types of particles 21p included in droplets 127. In the calibration step (S3; in particular, the first calibration step), the calibration beads are prevented from being collected in deflected-droplet collection members 75a, 75b. Therefore, in the particle sorting step (S4), particles 21p and the calibration beads are prevented from being mixed in deflected-droplet collection members 75a, 75b.

Since third pump 89 is being operated, check valve 86 is opened, and sample liquid 21 (other than sample liquid 21 collected in deflected-droplet collection members 75a, 75b) and sheath liquid 43 accumulated in waste-droplet collection member 76a are suctioned by third pump 89. Sample liquid 21 (other than sample liquid 21 collected in deflected-droplet collection members 75a, 75b) and sheath liquid 43 accumulated in waste-droplet collection member 76a are ejected to waste-liquid tank 90 through check valve 86. Check valve 86, rather than a sterilization filter, is provided in the waste-liquid flow path extending from waste-droplet collection member 76a to waste-liquid tank 90. Therefore, when particle 21p included in droplet 127 (final jet flow droplet 126f) is the third particle, the third particle is also ejected to waste-liquid tank 90 through check valve 86.

### Step (S5) of Removing Deflected-Droplet Collection Members 75a, 75b from Cartridge 2

The operations of first pump 28, second pump 42, third pump 89, vibration element 111, charge supply unit 112, first light source 115, and second light source 130 are halted. When the operation of third pump 89 is halted, check valve 86 is closed. The sample liquid flow path, the calibration liquid flow path, and the sheath liquid flow path are isolated from the surrounding environment around cartridge 2 by sterilization filters 26, 39, 59, 82, 83 and check valves 86, and the sample liquid flow path, the calibration liquid flow path, and the sheath liquid flow path are maintained in the sterile state.

Cartridge 2 is detached from body 3. Specifically, cartridge 2 is moved in a direction away from movable plate 100 of body 3. Tube 27 is removed from sterilization filter 26. Tube 27b is removed from sterilization filter 59. Tube 40 is removed from sterilization filter 39. Vibration electrode terminal 44 of mixer 36 is separated from vibration electrode 110 of body 3. Deflection electrode terminals 54a, 54b of deflection electrodes 53a, 53b are separated from electrode terminals 135a, 135b of body 3. Tube 85 of cartridge 2 is removed from tube 87. Even when cartridge 2 is detached from body 3, the sample liquid flow path, the calibration liquid flow path, and the sheath liquid flow path are maintained in the sterile state.

Cartridge 2 is then placed in the safety cabinet installed in the working area in the cell processing center (CPC). Deflected-droplet collection members 75a, 75b are removed from cartridge 2. Specifically, deflected-droplet collection members 75a, 75b are removed from cartridge 2 by pulling out deflected-droplet collection members 75a, 75b from first supporting block 70.

Cartridge 2 is provided with first funnel 61, second funnel 62, and tubes 77, 79. Each of the diameter of the lower opening of first funnel 61 and the diameter of tube 77 is smaller than the upper openings of deflected-droplet collection members 75a, 75b. Each of the diameter of the lower opening of second funnel 62 and the diameter of tube 78 is smaller than the upper openings of deflected-droplet collection members 75a, 75b. Therefore, when detaching cartridge 2 from body 3 after sorting particles 21p included in sample liquid 21, and when transporting cartridge 2 to the safety cabinet after sorting particles 21p included in sample liquid 21, sorted particles 21p can be prevented from leaking from deflected-droplet collection members 75a, 75b.

### MODIFICATIONS

Modifications of the present embodiment will be described.

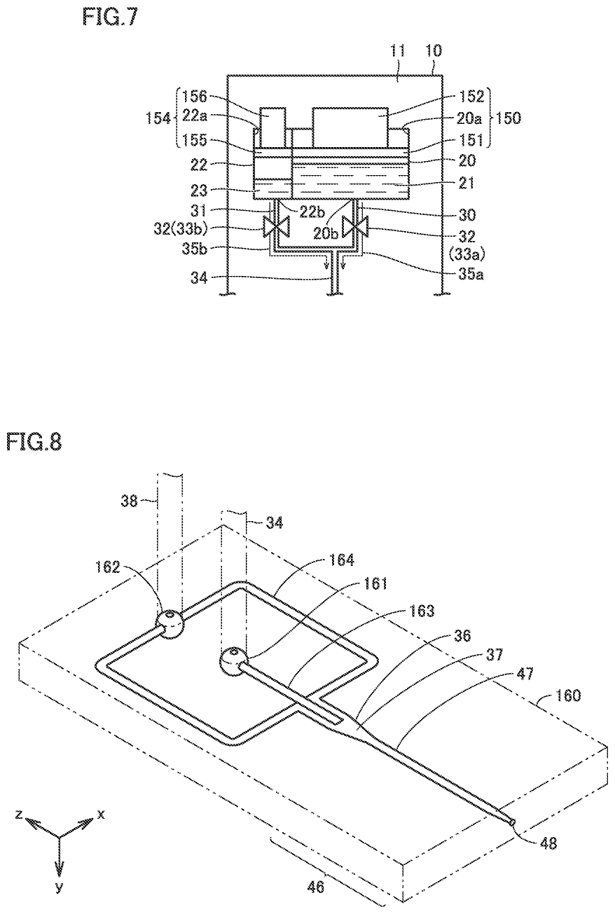

Referring to FIG. 7, in a first modification of the present embodiment, cartridge 2 includes a first gasket 151, a first plunger 152, a second gasket 155, and a second plunger 156 instead of tube 24 and sterilization filter 26. First gasket 151 is liquid-tightly and air-tightly in contact with the inner surface of first reservoir 20. First gasket 151 is pressed by first plunger 152 and is slidable in the first direction (z direction) with respect to first reservoir 20. First reservoir 20, first gasket 151, and first plunger 152 form a first syringe 150. Second gasket 155 is liquid-tightly and air-tightly in contact with the inner surface of second reservoir 22. Second gasket 155 is pressed by second plunger 156 and is slidable in the first direction (z direction) with respect to second reservoir 22. Second reservoir 22, second gasket 155, and second plunger 156 form a second syringe 154.

In the first modification of the present embodiment, first gasket 151, second gasket 155, sterilization filter 39, and check valve 86 can isolate the sample liquid flow path, the sheath liquid flow path, and the calibration liquid flow path from the surrounding environment around cartridge 2, and can maintain the sample liquid flow path, the sheath liquid flow path, and the calibration liquid flow path in the sterile state.

By moving first plunger 152 and first gasket 151 and by opening valve 33a, sample liquid 21 including particles 21p can be supplied to mixer 36. By moving second plunger 156 and second gasket 155 and by opening valve 33b, calibration liquid 23 including the calibration beads can be supplied to mixer 36. First plunger 152 and second plunger 156 are driven using a hydraulic driving apparatus (not shown) serving as driving unit 68. The hydraulic driving apparatus is provided at cartridge 2 or body 3. The operation of the hydraulic driving apparatus may be controlled by controller 137.

Referring to FIG. 8, in a second modification of the present embodiment, mixer 36 and flow channel portion 46 may be formed on a substrate 160. That is, mixer 36 and flow channel portion 46 may be microchips. Substrate 160 is composed of a material transparent to excitation light 116 emitted from first light source 115. Substrate 160 is composed of, for example, glass or a transparent resin.

A sample liquid injection port 161, a sheath liquid injection port 162, a first minute tube 163, a second minute tube 164, mixer 36, and flow channel 47 are formed at substrate 160. For example, each of the cross sectional shape of first minute tube 163, the cross sectional shape of second minute tube 164, and the cross sectional shape of flow channel 47 is a quadrangular shape such as a square shape, or is a circular shape.

First conduit 34 is connected to sample liquid injection port 161. Sample liquid 21 or calibration liquid 23 flows into mixer 36 through sample liquid injection port 161 and first minute tube 163. Second conduit 38 is connected to sheath liquid injection port 162. Sheath liquid 43 flows into mixer 36 through sheath liquid injection port 162 and second minute tube 164. In mixer 36, the sheath flow in which sample liquid 21 or calibration liquid 23 is enclosed with sheath liquid 43 is formed. The sheath flow is ejected from the outlet of mixer 36 and flows in flow channel 47 of flow channel portion 46. The sheath flow is released from nozzle 48 as jet flow 126. In a third modification of the present embodiment, in the first calibration step of the calibration step (S3), optical system 114 (first light source 115, optical detection system 119, and optical detector 120) of body 3 may be moved with respect to cartridge 2.

In a fourth modification of the present embodiment, cartridge 2 may include driving unit 68 (for example, first movable magnet 69a and second movable magnet 69b). That is, driving unit 68 may be provided at cartridge 2, rather than body 3. Specifically, driving unit 68 may be provided at base plate 10 or case 50, for example.

Effects of cartridge 2 and particle sorting apparatus 1 according to the present embodiment will be described.

Cartridge 2 of the present embodiment includes first reservoir 20, the sheath liquid conduit (second conduit 38), the first sterilization filter (sterilization filter 39), mixer 36, nozzle 48, droplet collection member 74, and check valve 86. First reservoir 20 is capable of accommodating sample liquid 21 including particles 21p. The first sterilization filter (sterilization filter 39) is provided at the sheath liquid conduit (second conduit 38). Mixer 36 is connected to first reservoir 20 and the sheath liquid conduit (second conduit 38). Nozzle 48 communicates with inner cavity 37 of mixer 36. Droplet collection member 74 is capable of collecting droplets 127 released from nozzle 48. Droplet collection member 74 includes waste-droplet collection member 76a and deflected-droplet collection members 75a, 75b. Check valve 86 is connected to waste-droplet collection member 76a. The sample liquid flow path and the sheath liquid flow path are isolated from the surrounding environment around cartridge 2 and are maintained in the sterile state. The sample liquid flow path extends from first reservoir 20 to droplet collection member 74. The sheath liquid flow path extends from the first sterilization filter (sterilization filter 39) to droplet collection member 74.

Cartridge 2 is thrown away when the sorting of particles 21p included in sample liquid 21 is finished. Therefore, with cartridge 2, particles 21p can be sorted without carryover of sample liquid 21. Further, the first sterilization filter (sterilization filter 39) and check valve 86 can isolate the sample liquid flow path and the sheath liquid flow path from the surrounding environment around cartridge 2 and can maintain the sample liquid flow path and the sheath liquid flow path in the sterile state. Thus, with cartridge 2, particles 21p can be sterilely sorted and the risk of biohazard to a user can be reduced.

Cartridge 2 of the present embodiment further includes second reservoir 22 and flow path switch 32. Second reservoir 22 is capable of accommodating calibration liquid 23 including the calibration beads. Second reservoir 22 is connected to mixer 36. The sample liquid flow path, the sheath liquid flow path, and the calibration liquid flow path are isolated from the surrounding environment around cartridge 2 and are maintained in the sterile state. The calibration liquid flow path extends from second reservoir 22 to droplet collection member 74. Flow path switch 32 is switchable between first flow path 35a and second flow path 35b, first flow path 35a extending from first outlet 20b of first reservoir 20 to mixer 36, second flow path 35b extending from second outlet 22b of second reservoir 22 to mixer 36. Therefore, cartridge 2 can perform the calibration step (S3) and the particle sorting step (S4) while maintaining the sample liquid flow path, the sheath liquid flow path, and the calibration liquid flow path in the sterile state.

Cartridge 2 of the present embodiment further includes droplet collection destination changeable member 65 capable of changing, between each of deflected-droplet collection members 75a, 75b and waste-droplet collection member 76a, the collection destination for droplets 127 released from nozzle 48 and deflected. Therefore, with cartridge 2, particles 21p can be sorted without mixing with calibration liquid 23 including calibration beads in deflected-droplet collection members 75a, 75b.

Cartridge 2 of the present embodiment further includes the second sterilization filter (sterilization filter 26) connected to first inlet 20a of first reservoir 20.

The first sterilization filter (sterilization filter 39), the second sterilization filter (sterilization filter 26) and check valve 86 can isolate the sample liquid flow path and the sheath liquid flow path from the surrounding environment around cartridge 2 and can maintain the sample liquid flow path and the sheath liquid flow path in the sterile state. Alternatively, the first sterilization filter (sterilization filter 39), the second sterilization filter (sterilization filter 26), and check valve 86 can isolate the sample liquid flow path, the sheath liquid flow path, and the calibration liquid flow path from the surrounding environment around cartridge 2, and can maintain the sample liquid flow path, the sheath liquid flow path, and the calibration liquid flow path in the sterile state. Thus, with cartridge 2, particles 21p can be sterilely sorted and the risk of biohazard to a user can be reduced.

Cartridge 2 of the present embodiment further includes: air vent tubes 80, 81 connected to deflected-droplet collection members 75a, 75b; and the third sterilization filters (sterilization filters 82, 83) provided at air vent tubes 80, 81.

Since cartridge 2 includes air vent tubes 80, 81, air pressures in deflected-droplet collection members 75a, 75b are prevented from being increased even when deflected droplets 127 are accumulated in deflected-droplet collection members 75a, 75b. Deflected droplets 127 are continuously and stably collected in deflected-droplet collection members 75a, 75b. Further, since the third sterilization filters (sterilization filters 82, 83) are provided at air vent tubes 80, 81, with cartridge 2, particles 21p can be sterilely sorted and the risk of biohazard to a user can be reduced.

Cartridge 2 of the present embodiment further includes deflection electrodes 53a, 53b that deflect droplets 127 released from nozzle 48.

Thus, the relative positions of deflection electrodes 53a, 53b with respect to the deflected-droplet collection members 75a, 75b are fixed. Deflected droplets 127 are more securely collected in the deflected-droplet collection members 75a, 75b.

Cartridge 2 of the present embodiment further includes case 50 disposed between mixer 36 and droplet collection member 74. Case 50 isolates, from the surrounding environment around cartridge 2, jet flow 126 released from nozzle 48, break-off point 125, and droplets 127. Case 50 includes first transparent portion 51 and second transparent portion 55. First transparent portion 51 allows for observation of at least one of jet flow 126, break-off point 125, or droplets 127. Second transparent portion 55 allows for observation of side streams 95, 96 formed by deflected droplets 127.

Therefore, when cartridge 2 is attached to body 3, while observing at least one of jet flow 126, break-off point 125, or droplets 127 or while observing side streams 95, 96, timing t_{c} at which the charges are started to be supplied from charge supply unit 112 to final jet flow droplet 126f in one cycle T of vibration of vibration element 111, or amplitude V₀ of the driving voltage to be applied to vibration element 111 can be adjusted. Particles 21p can be sorted more precisely and more stably.

Particle sorting apparatus 1 of the present embodiment includes cartridge 2 and body 3 to which cartridge 2 is attachable. Body 3 includes optical system 114 and moving mechanism 107 capable of moving one of cartridge 2 and optical system 114 with respect to the other of cartridge 2 and optical system 114. Optical system 114 includes the light source (first light source 115) capable of emitting excitation light 116 toward flow channel 47 that communicates with inner cavity 37 of mixer 36 and nozzle 48, and optical detector 120 capable of detecting fluorescence or scattered light 118 emitted from each of particles 21p that flow in flow channel 47 and that are irradiated with excitation light 116.

After finishing the sorting of particles 21p included in sample liquid 21, cartridge 2 is detached from body 3 and is thrown away. Therefore, with particle sorting apparatus 1, particles 21p can be sorted without carryover of sample liquid 21. Further, the first sterilization filter (sterilization filter 39) and check valve 86 can isolate the sample liquid flow path and the sheath liquid flow path from the surrounding environment around cartridge 2 and can maintain the sample liquid flow path and the sheath liquid flow path in the sterile state. Therefore, with particle sorting apparatus 1, particles 21p can be sorted sterilely and the risk of biohazard to a user can be reduced.

Further, particle sorting apparatus 1 includes moving mechanism 107 capable of moving one of cartridge 2 and optical system 114 with respect to the other of cartridge 2 and optical system 114. Therefore, with particle sorting apparatus 1, alignment can be readily made between cartridge 2 and optical system 114 while maintaining the sample liquid flow path in the sterile state. Further, with particle sorting apparatus 1, alignment can be readily made between cartridge 2 and optical system 114 while maintaining the sheath liquid flow path in the sterile state. Particles 21p can be sorted more precisely and more stably.

### Second Embodiment

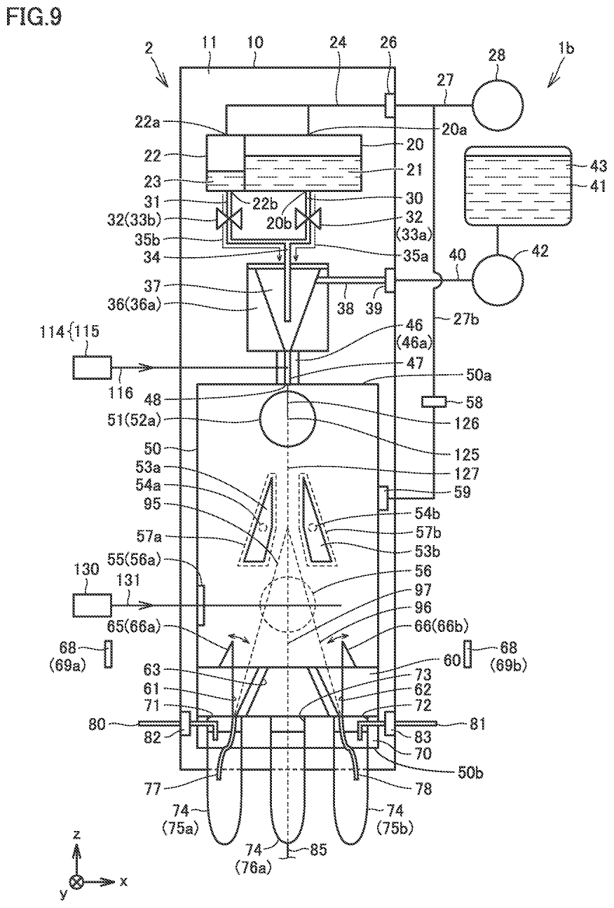

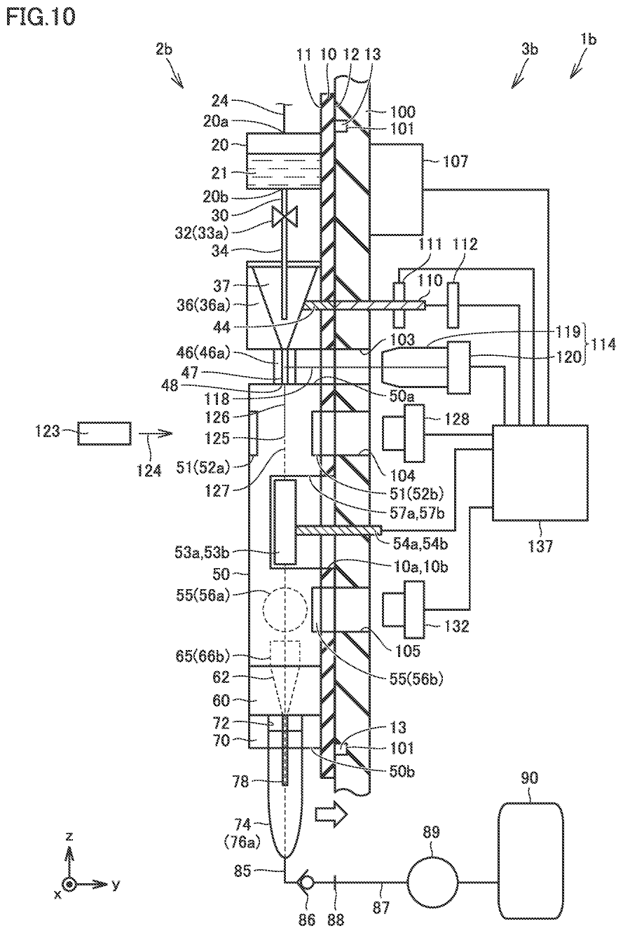

A cartridge 2b and a particle sorting apparatus 1b according to a second embodiment will be described with reference to FIGS. 9 and 10. Cartridge 2b and particle sorting apparatus 1b according to the present embodiment have the same configurations and exhibit the same effects as those of cartridge 2 and particle sorting apparatus 1 according to the first embodiment, but are different therefrom mainly in the following points.

In the present embodiment, deflection electrodes 53a, 53b are provided at body 3b, rather than cartridge 2b. Specifically, deflection electrode terminals 54a, 54b of deflection electrodes 53a, 53b are fixed to movable plate 100. Deflection electrodes 53a, 53b are fixed to movable plate 100 via deflection electrode terminals 54a, 54b. Holes 10a, 10b through which deflection electrodes 53a, 53b and deflection electrode terminals 54a, 54b extend are formed in base plate 10. Recesses 57a, 57b in which deflection electrodes 53a, 53b and deflection electrode terminals 54a, 54b can be accommodated are formed in case 50. When attaching cartridge 2b to movable plate 100, deflection electrode 53a passes through hole 10a of base plate 10 and is accommodated in recess 57a, and deflection electrode 53b passes through hole 10b of base plate 10 and is accommodated in recess 57b.

### Third Embodiment

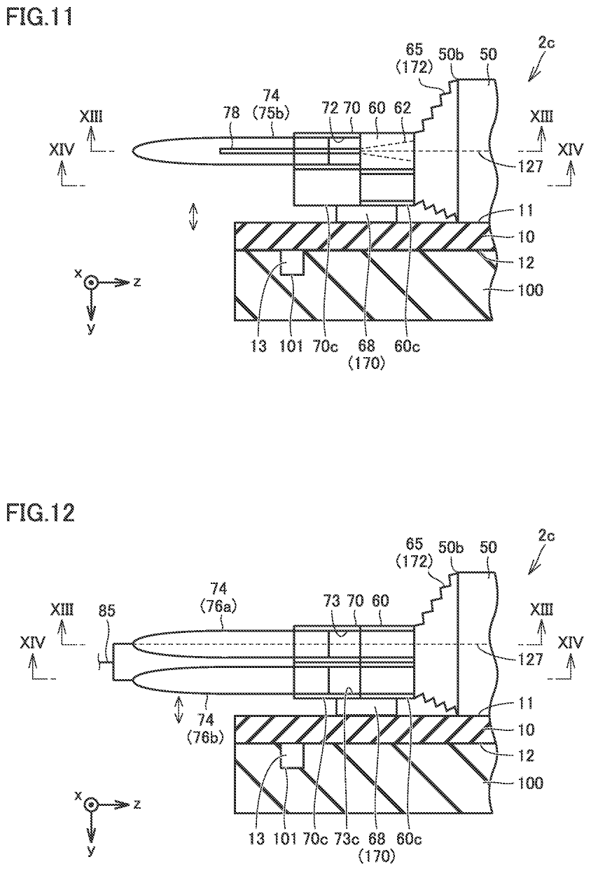

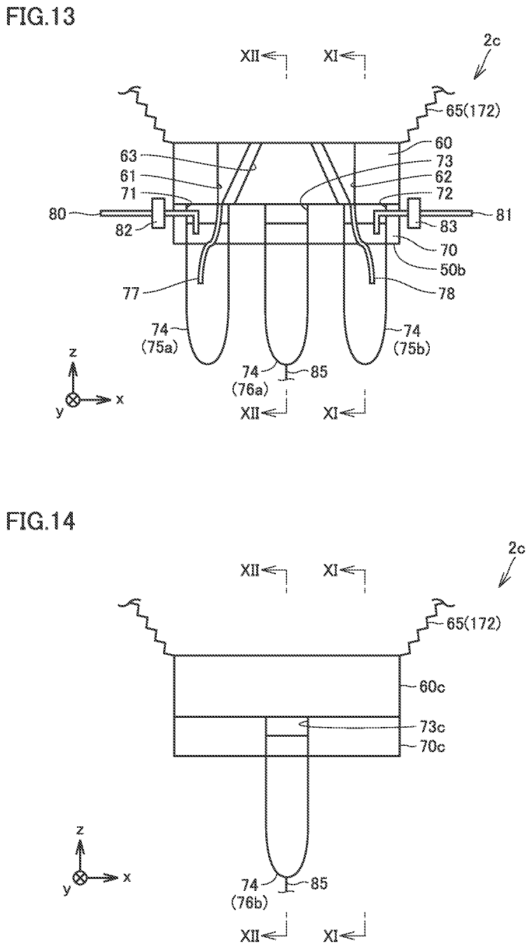

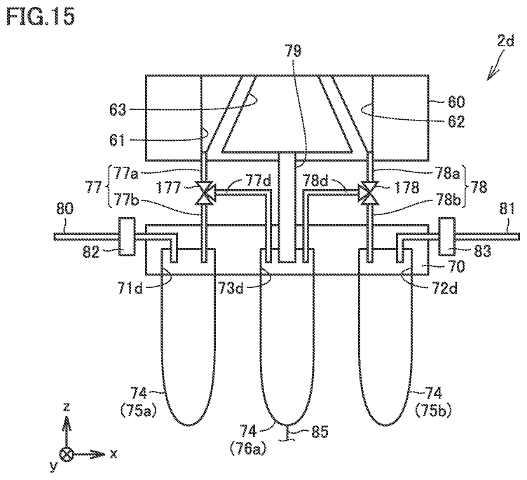

A cartridge 2c according to a third embodiment will be described with reference to FIGS. 11 to 14. Cartridge 2c of the present embodiment has the same configuration and exhibits the same effect as those of cartridge 2 of the first embodiment, but is different therefrom in the following point: cartridge 2c includes a flexible tubular body 172 as droplet collection destination changeable member 65 instead of first cover 66a and second cover 66b (see FIGS. 1 and 2).

Specifically, cartridge 2c includes a second block 60c, a second supporting block 70c, and flexible tubular body 172. Cartridge 2c may include an actuator 170 as driving unit 68. Droplet collection member 74 further includes a waste-droplet collection member 76b. Tube 85 is connected to waste-droplet collection member 76a and waste-droplet collection member 76b.

Second block 60c is stacked on first block 60 in the direction (third direction (y direction)) normal to first main surface 11 of base plate 10. Second block 60c is joined to first block 60. Second supporting block 70c is stacked on first supporting block 70 in the direction normal to first main surface 11 of base plate 10. Second supporting block 70c is joined to first supporting block 70. Second supporting block 70c is airtightly fixed to second block 60c. Second supporting block 70c is located away from lower end 50b of case 50 with respect to second block 60c.

Second block 60c is a hollow member. Second block 60c includes an upper end close to case 50 and a lower end close to droplet collection member 74 or second supporting block 70c. An upper end opening is provided at the upper end of second block 60c. A lower end opening is provided at a portion of the lower end of second block 60c in conformity with a through hole 73c provided in second supporting block 70c.

Second supporting block 70c supports waste-droplet collection member 76b. Specifically, waste-droplet collection member 76b is fitted in through hole 73c of second block 60c. Through hole 73c communicates with the cavity of second block 60c. Waste-droplet collection member 76b is airtightly connected to second block 60c.

Lower end 50b of case 50 and the upper ends of first block 60 and second block 60c are connected by flexible tubular body 172 that is in the form of bellows. Flexible tubular body 172 is airtightly connected to case 50. Flexible tubular body 172 is airtightly connected to the upper ends of first block 60 and second block 60c. With flexible tubular body 172, first block 60, second block 60c, first supporting block 70, and second supporting block 70c can be moved with respect to case 50.

When second block 60c and second supporting block 70c are retracted from the path for droplets 127 and first block 60 and first supporting block 70 are positioned in the path for droplets 127, deflected droplets 127 are collected in deflected-droplet collection members 75a, 75b. When first block 60 and first supporting block 70 are retracted from the path for droplets 127 and second block 60c and second supporting block 70c are positioned in the path for droplets 127, deflected droplets 127 are collected in waste-droplet collection member 76b. In this way, flexible tubular body 172 can change, between each of deflected-droplet collection members 75a, 75b and waste-droplet collection member 76b, the collection destination for droplets 127 released from nozzle 48 and deflected.

Actuator 170 is provided on base plate 10, for example. In one example, actuator 170 is disposed between second block 60c and base plate 10. Actuator 170 can move first block 60, second block 60c, first supporting block 70, and second supporting block 70c with respect to case 50 in a direction perpendicular to the falling direction (first direction (z direction)) of droplet 127. In one example, actuator 170 can move first block 60, second block 60c, first supporting block 70, and second supporting block 70c in the direction (third direction (y direction)) normal to base plate 10.

The particle sorting method according to the present embodiment includes the same steps as those of the particle sorting method according to the first embodiment, but is different therefrom mainly in the following points.

In the calibration step (S3) shown in FIG. 5, actuator 170 is used to retract first block 60 and first supporting block 70 from the path for droplets 127 and to position second block 60c and second supporting block 70c in the path for droplets 127. In the calibration step (S3), deflected droplets 127 are collected in waste-droplet collection member 76b. In the particle sorting step (S4) shown in FIG. 5, actuator 170 is used to retract second block 60c and second supporting block 70c from the path for droplets 127 and to position first block 60 and first supporting block 70 in the path for droplets 127. In the particle sorting step (S4), deflected droplets 127 are collected in deflected-droplet collection members 75a, 75b.

In the modification of the present embodiment, actuator 170 serving as driving unit 68 may be provided at body 3, rather than cartridge 2c.

### Fourth Embodiment

A cartridge 2d according to a fourth embodiment will be described with reference to FIG. 15. Cartridge 2d of the present embodiment has the same configuration and exhibits the same effect as those cartridge 2 of the first embodiment, but is different therefrom mainly in the following point: cartridge 2d includes a plurality of valves 177, 178 as droplet collection destination changeable member 65 instead of first cover 66a and second cover 66b (see FIGS. 1 and 2).

Specifically, cartridge 2d includes the plurality of valves 177, 178 and tubes 77d, 78d, 79. The plurality of valves 177, 178 are, for example, three-way valves. Valve 177 is provided at a portion of tube 77, and tube 77 is divided into a tube 77a and a tube 77b. Tube 77a is airtightly connected to the lower opening of first funnel 61 and valve 177. Tube 77b is airtightly connected to valve 177 and deflected-droplet collection member 75a. Tube 77d is airtightly connected to valve 177 and waste-droplet collection member 76a.

Valve 178 is provided at a portion of tube 78, and tube 78 is divided into a tube 78a and a tube 78b. Tube 78a is airtightly connected to the lower opening of second funnel 62 and valve 178. Tube 78b is airtightly connected to valve 178 and deflected- droplet collection member 75b. Tube 78d is airtightly connected to valve 178 and waste-droplet collection member 76a. Tube 79 is airtightly connected to central opening 63 of first block 60 and waste-droplet collection member 76a.

First block 60 is spaced from first supporting block 70 in the falling direction (first direction (z direction)) of droplet 127. The plurality of valves 177, 178 and tubes 77, 77d, 78, 78d, 79 are disposed between first supporting block 70 and second supporting block 70c. In the lower end of central opening 63 of first block 60, only a portion corresponding to tube 78 is opened.

Recesses 71d, 72d, 73d are provided in first supporting block 70. Deflected-droplet collection members 75a, 75b are fitted in recesses 71d, 72d. Waste-droplet collection member 76a is fitted in recess 73d. Droplet collection member 74 (deflected-droplet collection members 75a, 75b and waste-droplet collection member 76a) is airtightly connected to first supporting block 70.

Valve 177 opens the flow path from tube 77a to tube 77b and closes the flow path from tube 77a to tube 77d. Valve 178 opens the flow path from tube 78a to tube 78b and closes the flow path from tube 78a to tube 78d. Deflected droplets 127 are collected in deflected-droplet collection members 75a, 75b. Valve 177 closes the flow path from tube 77a to tube 77b and opens the flow path from tube 77a to tube 77d. Valve 178 closes the flow path from tube 78a to tube 78b and opens the flow path from tube 78a to tube 78d. Deflected droplets 127 are collected in waste-droplet collection member 76a. In this way, the plurality of valves 177, 178 can change, between each of deflected-droplet collection members 75a, 75b and waste-droplet collection member 76a, the collection destination for droplets 127 released from nozzle 48 and deflected.

The plurality of valves 177, 178 may be manually operated. The plurality of valves 177, 178 may be electromagnetic valves. When the plurality of valves 177, 178 are electromagnetic valves, a solenoid (not shown) included in each of the electromagnetic valves functions as driving unit 68. When the plurality of valves 177, 178 are electromagnetic valves, the opening/closing operations of the plurality of valves 177, 178 may be controlled by controller 137.

The particle sorting method of the present embodiment includes the same steps as those of the particle sorting method of the first embodiment, but is different therefrom mainly in the following points.

In the calibration step (S3) shown in FIG. 5, valve 177 closes the flow path from tube 77a to tube 77b and opens the flow path from tube 77a to tube 77d. Valve 178 closes the flow path from tube 78a to tube 78b and opens the flow path from tube 78a to tube 78d. In the calibration step (S3), deflected droplets 127 are collected in waste-droplet collection member 76a. In the particle sorting step (S4) shown in FIG. 5, valve 177 opens the flow path from tube 77a to tube 77b and closes the flow path from tube 77a to tube 77d. Valve 178 opens the flow path from tube 78a to tube 78b and closes the flow path from tube 78a to tube 78d. In the particle sorting step (S4), deflected droplets 127 are collected in deflected-droplet collection members 75a, 75b.

### Fifth Embodiment

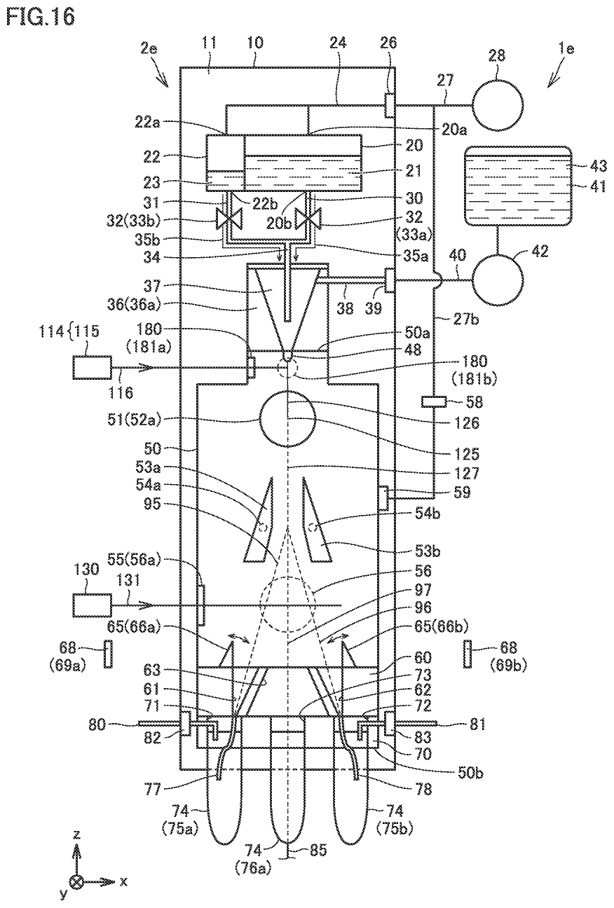

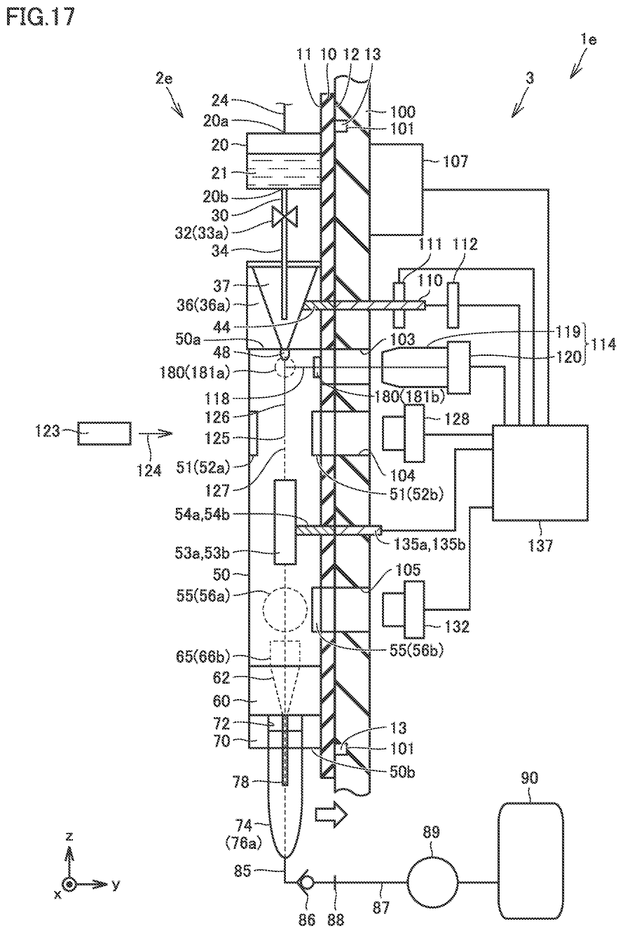

A cartridge 2e and a particle sorting apparatus 1e according to a fifth embodiment will be described with reference to FIGS. 16 and 17. Cartridge 2e and particle sorting apparatus 1e according to the present embodiment have the same configurations and exhibit the same effects as those of cartridge 2 and particle sorting apparatus 1 according to the first embodiment, but are different therefrom mainly in the following points.

Cartridge 2e includes no flow channel portion 46 (see FIG. 1). In cartridge 2e, nozzle 48 is attached to mixer 36. Nozzle 48 communicates with inner cavity 37 of mixer 36. Upper end 50a of case 50 is airtightly connected to the lower end of mixer 36. Nozzle 48 is disposed in the inner space of case 50.

Case 50 includes a third transparent portion 180. Third transparent portion 180 permits passage of excitation light 116 from first light source 115, and permits passage of fluorescence or scattered light 118 emitted from each of particles 21p (see FIG. 3) or the calibration beads included in jet flow 126, to optical detection system 119 and optical detector 120. Specifically, third transparent portion 180 includes transparent windows 181a, 181b. Transparent window 181a faces first light source 115. Transparent window 181b faces optical detection system 119. Transparent window 181a can permit passage of excitation light 116 emitted from first light source 115. Transparent window 181b can permit passage of fluorescence or scattered light 118 emitted from particles 21p or the calibration beads included in jet flow 126.

First light source 115 can emit excitation light 116 toward jet flow 126 sent out from nozzle 48. Particles 21p or the calibration beads included in jet flow 126 are irradiated with excitation light 116. The fluorescent or scattered light 118 is generated from particles 21p or the calibration beads. Optical detection system 119 guides, to optical detector 120, fluorescence or scattered light 118 generated from particles 21p or the calibration beads included in jet flow 126. Optical detector 120 can detect fluorescence or scattered light 118 emitted from particles 21p or the calibration beads included in jet flow 126.

Particle sorting apparatus 1e of the present embodiment has the same below-described effects as those of particle sorting apparatus 1 of the first embodiment.

Particle sorting apparatus 1e of the present embodiment includes cartridge 2e and body 3 to which cartridge 2e is attachable. Body 3 includes optical system 114 and moving mechanism 107 capable of moving one of cartridge 2e and optical system 114 with respect to the other of cartridge 2e and optical system 114. Optical system 114 includes the light source (first light source 115) and optical detector 120. The light source (first light source 115) is capable of emitting excitation light 116 toward jet flow 126 sent out from nozzle 48. Optical detector 120 is capable of detecting fluorescence or scattered light 118 emitted from each of particles 21p that are included in jet flow 126 and that are irradiated with excitation light 116.

When the sorting of particles 21p included in sample liquid 21 is finished, cartridge 2e is detached from body 3 and is thrown away. Therefore, with particle sorting apparatus 1e, particles 21p can be sorted without carryover of sample liquid 21. Further, the first sterilization filter (sterilization filter 39) and check valve 86 can isolate the sample liquid flow path and the sheath liquid flow path from the surrounding environment around cartridge 2e and can maintain the sample liquid flow path and the sheath liquid flow path in the sterile state. Therefore, with particle sorting apparatus 1e, particles 21p can be sorted sterilely and the risk of biohazard to a user can be reduced.

Further, particle sorting apparatus 1e includes moving mechanism 107 capable of moving one of cartridge 2e and optical system 114 with respect to the other of cartridge 2e and optical system 114. Therefore, with particle sorting apparatus 1e, alignment can be readily made between cartridge 2e and optical system 114 while maintaining the sample liquid flow path and the sheath liquid flow path in the sterile state. Particles 21p can be sorted more precisely and more stably.

The first to fifth embodiments and modifications thereof disclosed herein should be regarded as being illustrative and non-restrictive in any respect. At least two of the first to fifth embodiments and the modifications thereof disclosed herein may be combined as long as there is no contradiction. The scope of the present disclosure is defined by the terms of the claims, rather than the embodiments described above, and is intended to include any modifications within the scope and meaning equivalent to the terms of the claims.

### REFERENCE SIGNS LIST

1, 1b, 1e: particle sorting apparatus; 2, 2b, 2c, 2d, 2e: cartridge; 3, 3b: body; 10: base plate; 10a, 10b: hole; 11: first main surface; 12: second main surface; 13: pin; 20: first reservoir; 20a: first inlet; 20b: first outlet; 21: sample liquid; 21p: particle; 22: second reservoir; 22a: second inlet; 22b: second outlet; 23: calibration liquid; 24, 27, 27b, 40, 85, 87: tube; 26, 39, 59, 82, 83: sterilization filter; 28: first pump; 30: sample liquid conduit; 31: calibration liquid conduit; 32: flow path switch; 33a, 33b: valve; 34: first conduit; 35a: first flow path; 35b: second flow path; 36: mixer; 36a: chamber; 37: inner cavity; 38: second conduit; 41: sheath-liquid tank; 42: second pump; 43: sheath liquid; 44: vibration electrode terminal; 46: flow channel portion; 46a: flow cell; 47: flow channel; 48: nozzle; 50: case; 50a: upper end; 50b: lower end; 51: first transparent portion; 52a, 52b, 56a, 56b, 181a, 181b: transparent window; 53a, 53b: deflection electrode; 54a, 54b: deflection electrode terminal; 55: second transparent portion; 57a, 57b: recess; 58: pressure reduction valve; 60: first block; 60c: second block; 61: first funnel; 62: second funnel; 63: central opening; 65: droplet collection destination changeable member; 66a: first cover; 66b: second cover; 68: actuator; 69a: first movable magnet; 69b: second movable magnet; 70: first supporting block; 70c: second supporting block; 71, 72, 73, 73c: through hole; 71d, 72d, 73d: recess; 74: droplet collection member; 75a, 75b: deflected-droplet collection member; 76a, 76b: waste-droplet collection member; 77, 77a, 77b, 77d, 78, 78a, 78b, 78d, 79: tube; 80, 81: air vent tube; 86: check valve; 88: tube connection portion; 89: third pump; 90: waste-liquid tank; 95, 96: side stream; 97: center stream; 100: movable plate; 101: recess; 103, 104, 105: hole; 107: moving mechanism; 110: vibration electrode; 111: vibration element; 112: charge supply unit; 114: optical system; 115: first light source; 116: excitation light; 118: fluorescence or scattered light; 119: optical detection system; 120: optical detector; 123: strobe light; 124: first illumination light; 125: break-off point; 126: jet flow; 126a: jet flow droplet; 126b: contraction portion; 126f: final jet flow droplet; 127: droplet; 127s: satellite drop; 128: first imaging element; 130: second light source; 131: second illumination light; 132: second imaging element; 135a, 135b: electrode terminal; 137: controller; 150: first syringe; 151: first gasket; 152: first plunger; 154: second syringe; 155: second gasket; 156: second plunger; 160: substrate; 161: sample liquid injection port; 162: sheath liquid injection port; 163: first minute tube; 164: second minute tube; 170: actuator; 172: flexible tubular member; 177, 178: valve; 180: third transparent portion.

1. A cartridge comprising:
a first reservoir capable of accommodating a sample liquid including particles;
a sheath liquid conduit;
a first sterilization filter provided at the sheath liquid conduit;
a mixer connected to the first reservoir and the sheath liquid conduit;
a nozzle that communicates with an inner cavity of the mixer;
a droplet collection member capable of collecting droplets released from the nozzle, the droplet collection member including a waste-droplet collection member and a deflected-droplet collection member; and
a check valve connected to the waste-droplet collection member, wherein
a sample liquid flow path extending from the first reservoir to the droplet collection member and a sheath liquid flow path extending from the first sterilization filter to the droplet collection member are isolated from a surrounding environment around the cartridge and are maintained in a sterile state.

2. The cartridge according to claim 1, further comprising:
a second reservoir capable of accommodating a calibration liquid including calibration beads; and
a flow path switch, wherein
the second reservoir is connected to the mixer;
the sample liquid flow path, the sheath liquid flow path, and a calibration liquid flow path extending from the second reservoir to the droplet collection member are isolated from the surrounding environment and are maintained in the sterile state, and
the flow path switch is switchable between a first flow path and a second flow path, the first flow path extending from a first outlet of the first reservoir to the mixer, the second flow path extending from a second outlet of the second reservoir to the mixer.

3. The cartridge according to claim 2, further comprising a droplet collection destination changeable member capable of changing, between the deflected-droplet collection member and the waste-droplet collection member, a collection destination for the droplets released from the nozzle and deflected.

4. The cartridge according to claim 1, further comprising a second sterilization filter connected to a first inlet of the first reservoir.

5. The cartridge according to claim 1, further comprising:
an air vent tube connected to the deflected-droplet collection member; and
a third sterilization filter provided at the air vent tube.

6. The cartridge according to claim 1, further comprising a deflection electrode that deflects the droplets released from the nozzle.

7. The cartridge according to claim 1, further comprising a case disposed between the mixer and the droplet collection member, wherein
the case isolates, from the surrounding environment, a jet flow released from the nozzle, a break-off point, and the droplets,
the case includes a first transparent portion and a second transparent portion,
the first transparent portion allows for observation of at least one of the jet flow, the break-off point, or the droplets, and
the second transparent portion allows for observation of a side stream formed by the deflected droplets.

8. A particle sorting apparatus comprising:
the cartridge according to claim 1; and
a body to which the cartridge is attachable, wherein
the body includes an optical system and a moving mechanism capable of moving one of the cartridge and the optical system with respect to the other of the cartridge and the optical system, and
the optical system includes a light source capable of emitting excitation light toward a flow channel that communicates with the inner cavity of the mixer and the nozzle, and an optical detector capable of detecting fluorescence or scattered light emitted from each of the particles that flow in the flow channel and that are irradiated with the excitation light.

9. A particle sorting apparatus comprising:
the cartridge according to claim 1; and
a body to which the cartridge is attachable,
the body includes an optical system and a moving mechanism capable of moving one of the cartridge and the optical system with respect to the other of the cartridge and the optical system, and
the optical system includes a light source capable of emitting excitation light toward a jet flow sent out from the nozzle, and an optical detector capable of detecting fluorescence or scattered light emitted from each of the particles that are included in the jet flow and that are irradiated with the excitation light.
